(19) United States
(12) Patent Application Publication
(10) Pub. No.: US 2025/0046144 A1
(43) Pub. Date: Feb. 6, 2025

(54) GUI FOR SLOT MACHINE GAME WITH UPGRADEABLE FRENZY MODES

(71) Applicant: Aristocrat Technologies, Inc., Las Vegas, NV (US)

(72) Inventors: Carlyn Albright, Reno, NV (US); Erick Ching, Cedar Park, TX (US); Rogelio Decasa, JR., Renton, WA (US); Nicholas Farina, Granger, IN (US); Deanna Hickox, Georgetown, TX (US); Scott Hopkins, Austin, TX (US); Kelly Lockheed, Elkridge, MD (US); Ginette McKay, Austin, TX (US); Jennifer Mizzi, Ewa Beach, HI (US); Steve Richardson, Round Rock, TX (US); Hanna Sanborn, Georgetown, TX (US); Zachary Smith, Austin, TX (US); Nathan Warms, Austin, TX (US)

(21) Appl. No.: 18/362,545

(22) Filed: Jul. 31, 2023

(51) Int. Cl. G07F 17/32; G07F 17/34

(52) U.S. Cl. CPC G07F 17/3211; G07F 17/34

(57) ABSTRACT

A graphical user interface for providing a game of chance with upgradeable feature symbols and meters reflecting progress towards satisfaction of goals that cause such a feature symbol upgrade.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

In some games of chance, e.g., slot-type games, there may be certain symbols that, when displayed (or when at least a certain number of them are displayed) as part of a game outcome cause awards specific to each such symbol to be awarded to the player. Such symbols are typically referred to as “cash-on-reel” symbols.

### SUMMARY

Disclosed herein are slot machine games in which a base game GUI includes one or more meters that track the player's progress towards a corresponding feature goal. The feature goal(s) associated with each such meter are met when a particular, cumulative number of trigger symbols have been displayed on corresponding feature symbols in base game outcomes, e.g., “collected” by the player, since the meter in question was last initialized. When such a feature goal is met, the base game GUI first transitions to operating in a corresponding “frenzy mode” in which all of the feature symbols corresponding to that meter that are displayed as a result of a base game play while the frenzy mode is active are enhanced in some manner as compared with corresponding feature symbols prior to the feature goal being met. This frenzy mode persists for a predetermined period of time. The period of time is typically relatively short, e.g., 30 seconds, a minute, 90 seconds, etc., such that a player that plays rapidly, e.g., in a frenzied manner, during the frenzy mode is likely to derive more benefit from the enhanced state of the corresponding feature symbols as compared with a player that plays more sedately.

Once the frenzy mode has been active for the predetermined period of time, the frenzy mode may be deactivated. However, each corresponding feature symbol for that frenzy mode may now, if displayed in response to a base game play, be either a non-enhanced version (similar to the versions of the corresponding feature symbols that were displayed prior to the first feature goal of the corresponding meter being met) an enhanced version of that feature symbol.

For example, a base game GUI may have a first collection meter that tracks a player's progress towards meeting a first feature first collection goal and a first feature second collection goal, as well as a second collection meter that tracks the player's progress towards meeting a second feature first collection goal and a second feature second collection goal. The first feature first and second collection goals may each be met when a corresponding cumulative number of trigger symbols have been included in feature symbols of a first type displayed in base game outcomes that have occurred since the first collection meter was last initialized. Similarly, the second feature first and second collection goals may each be met when a corresponding cumulative number of trigger symbols have been included in feature symbols of a second type displayed in base game outcomes that have occurred since the second collection meter was last initialized.

In such a base game GUI, the feature symbols may, for example, be symbols such as coins, bags of money, etc., and the feature symbols of the first type may be easily distinguishable from the feature symbols of the second type, e.g., the feature symbols of the first type may appear similar in shape and appearance to the feature symbols of the second type, but may all be a different color from the feature symbols of the second type. In other instances, the feature symbols of the first type may be completely different from the feature symbols of the second type, e.g., the feature symbols of the first type may each depict one or more coins, while the feature symbols of the second type may each depict a money bag. However, in such an implementation, the feature symbols of the first type and the feature symbols of the second type may both be considered to be “feature symbols.”

The feature symbols may, for example, each include one or more trigger symbols. The trigger symbols that are included in feature symbols of the first type in a base game outcome may cause the base game GUI to update the first collection meter accordingly. For example, if six trigger symbols are included in feature symbols of the first type in a base game outcome, the first collection meter may be updated to reflect that the cumulative number of trigger symbols included in the feature symbols of the first type that have been displayed in base game outcomes since the first collection meter was last initialized has increased by six.

Similarly, the trigger symbols that are included in feature symbols of the second type in a base game outcome may cause the base game GUI to update the second collection meter accordingly. For example, if four trigger symbols are included in feature symbols of the second type in a base game outcome, the second collection meter may be updated to reflect that the cumulative number of trigger symbols included in the feature symbols of the second type that have been displayed in base game outcomes since the second collection meter was last initialized has increased by four.

In addition to contributing towards the achievement of a first feature or second feature first collection goal or second collection goal, the trigger symbols that are displayed in base game outcomes may also serve to trigger a bonus game. For example, if at least a predetermined number of trigger symbols, e.g., six trigger symbols, are displayed in a base game outcome, this may cause the base game GUI to transition to a bonus game GUI. The bonus game GUI may, for example, be a GUI for a hold-and-spin game in which any feature symbols of the first type or the second type that are displayed are “held” in place for subsequent bonus game plays and a player is given an initial number of bonus game plays in which each play of the bonus game causes new symbols to be selected and displayed in any symbol positions which do not have a feature symbol of the first type or the second type already displayed (“held”). The number of bonus game plays that are available to the player may be “reset” back to the initial number of bonus game plays after a bonus game outcome results a feature symbol being displayed in a symbol position that did not have a feature symbol displayed therein immediately prior to that bonus game outcome. Once the bonus game concludes, the bonus game GUI may be caused to revert back to the base game GUI for further base game play. In some implementations, each trigger symbol displayed by the bonus game GUI may be associated with a corresponding value that is then added to, for example, a score or credit meter associated with the game at the conclusion of bonus game play.

As discussed above, the feature symbols corresponding to the first collection meter and the second collection meter may have enhanced states that are “unlocked” after the first feature or second feature first or second collection goals are met. For example, the feature symbols of the first type may always include only a single trigger symbol during base game plays that occur prior to the first feature first collection goal being met. However, once the first feature first collection goal is met, feature symbols of the first type that are displayed in a base game outcome may be feature symbols of the first type with either a single trigger symbol or with two trigger symbols. Similarly, once the first feature second collection goal is met, feature symbols of the first type that are displayed in a base game outcome may be feature symbols of the first type with either a single trigger symbol or with three trigger symbols. The enhanced symbols of the first type, when displayed as part of a base game outcome, may thus a) accelerate the rate at which the first feature second collection goal is met and b) make it easier to trigger the bonus game from the base game. Moreover, at the conclusion of bonus game play, such enhanced symbols of the first type would include multiple trigger symbols, each associated with its own value that is then added to the player's score or credit meter.

In a further example, the feature symbols of the second type may always include only a single trigger symbol. However, once the second feature first collection goal is met, feature symbols of the second type that are displayed in a base game outcome may be feature symbols of the second type that are associated with an “instant award” status or that are not associated with an “instant award” status. When a feature symbol of the second type is displayed in a base game or bonus game outcome, the value that is associated with the trigger symbol thereof may be instantly added to the player's score or credit meter. Thus, for example, a feature symbol of the second type that is associated with “instant award” status that is displayed during bonus game play will have the value associated with the trigger symbol thereof added to the player's score or credit meter twice-once when that feature symbol is first displayed, and again at the conclusion of that bonus game.

Once the second feature second collection goal is met, feature symbols of the second type that are displayed in a base game outcome may be feature symbols of the second type with either “instant award” status and an associated multiplier or without “instant award” status and the associated multiplier. Feature symbols of the second type with the “instant award” status and the associated multiplier may be treated in the same manner as the feature symbols of the second type with just the “instant award” status except that the values added to the score or credit meter in connection with such feature symbols may be multiplied by the multiplier prior to being added to the score or credit meter.

As noted above, any feature symbols of the first type that are displayed in base game outcomes that occur while the frenzy mode is activated responsive to the first feature first or second collection goal being met are active may be only the feature symbols of the first type that are at the highest enhancement state that has been unlocked thus far (but since the first collection meter was last initialized) for the feature symbols of the first type. Thus, when the first feature first collection goal is met, any of the feature symbols of the first type that are displayed in a base game outcome during the frenzy mode that is then triggered will be feature symbols of the first type that include two trigger symbols. Similarly, when the first feature second collection goal is met, any of the feature symbols of the first type that are displayed in a base game outcome during the frenzy mode that is then triggered will be feature symbols of the first type that include three trigger symbols.

In an analogous manner, any feature symbols of the second type that are displayed in base game outcomes that occur while the frenzy mode is activated responsive to the second feature first or second collection goal being met are active may be only the feature symbols of the second type that are at the highest enhancement state that has been unlocked thus far (but since the second collection meter was last initialized) for the feature symbols of the second type. Thus, when the second feature first collection goal is met, any of the feature symbols of the second type that are displayed in a base game outcome during the frenzy mode that is then triggered will be feature symbols of the second type that are associated with “instant award” status (and will thus result in the value associated therewith being immediately added to the player's score or credit meter). Similarly, when the second feature second collection goal is met, any of the feature symbols of the second type that are displayed in a base game outcome during the frenzy mode that is then triggered will be feature symbols of the second type that are associated with “instant award” status and an associated multiplier (and will thus result in the value associated therewith being immediately added to the player's score or credit meter after being multiplied by the multiplier).

It will be appreciated that in some implementations, when a feature symbol of a particular type is upgraded to an enhanced state, then a frenzy mode in which all feature symbols of that type that are displayed are caused to be in that enhanced state may be initiated for a limited duration of time. Following such a frenzy mode, the feature symbols of that type that are shown in a game outcome may be either the non-enhanced version of that feature symbol type or the enhanced version of that feature symbol type. In cases where a feature symbol type has been enhanced or upgraded multiple times, the “enhanced” version of the feature symbol type may always be the highest level of enhancement that has been unlocked (at least, until the feature symbols of that type have been reset to their default states).

In some other implementations, however, feature symbols of a particular type that have been upgraded multiple times may have enhanced states that may be any of the levels of enhancement that have been unlocked. For example, if a feature symbol of the first type has had the second level of enhancement unlocked, e.g., where such enhanced feature symbols display three trigger symbols, a feature symbol that is displayed as part of a game outcome (at least, during non-frenzy game play), may be either unenhanced (1 trigger symbol), enhanced to the first level of enhancement (2 trigger symbols), or enhanced to the second level of enhancement (3 trigger symbols).

Particular implementations in which feature symbols are upgradeable so as to potentially have multiple trigger symbols that may be used to satisfy a bonus game trigger condition allow base game GUIs to provide for enhanced opportunities for triggering such a bonus game without necessarily resorting to increasing the size of the symbol position array or increasing the frequency with which trigger symbols are shown in symbol positions. For example, if six or more trigger symbols are required to be displayed in an array of symbol positions in order to trigger a bonus game, there are usually only two ways of increasing the base chance of having six or more trigger symbols be displayed-expanding the array of symbol positions, thereby increasing the number of symbol positions that may be caused to display a trigger symbol during a play of the base game, or increasing the frequency with which such trigger symbols are displayed in the symbol positions. The former solution consumes display real estate, as portions of the display area that could be used to display other graphical content must instead be used to display the additional symbol positions. This prevents such display real estate from being used, for example, to display streaming video, advertising, game information, celebratory animations, etc. The latter solution necessarily reduces the frequency of occurrence of other, non-trigger symbols, e.g., symbols that may not have an effect with regard to triggering a bonus game but which may be used to form winning patterns during base game play, e.g., five of the same symbol along a payline. However, GUIs in which a feature symbol type is able to be upgraded to potentially show more than one trigger symbol provide a technical benefit in that they allow for increased chances of triggering the bonus game without requiring the sacrifice of display real estate during base game play and without requiring that the frequency of display of other non-trigger symbols be reduced. This allows a base game that incorporates such a feature to allow a player to, through extended play, improve their chances of triggering bonus game play without necessarily sacrificing display real estate or affecting the chances of obtaining winning patterns during base game play.

The present disclosure is, at the least, directed at the following implementations, although it will be apparent that other implementations are evident from the disclosure as well.

In some implementations, an electronic gaming machine may be provided that includes one or more displays, one or more processors, and one or more memory devices. The one or more memory devices may store computer-executable instructions which, when executed by the one or more processors, cause the one or more processors to: cause a base game GUI to be displayed on the one or more displays, the base game GUI including an array of symbol positions and a first collection meter indicating progress towards meeting a first feature first collection goal, cause a first feature first mode to be activated responsive to initialization of the first collection meter and deactivated responsive to the first feature first collection goal being met, cause a first feature first frenzy mode to be activated responsive to the first feature first collection goal being met and deactivated after being active for a first feature first predetermined cumulative time period, cause a first feature second mode to be activated responsive to deactivation of the first feature first frenzy mode, and cause, for each base game play using the base game GUI, symbols to be displayed in the symbol positions. The symbols displayed in one or more of the symbol positions for each base game play may each be drawn from symbols including feature symbols and non-feature symbols, the feature symbols may at least include feature symbols of a first type, and each feature symbol of the first type may include only a first amount of corresponding trigger symbols while the first feature first mode is active. Each feature symbol of the first type may also include only a second amount of corresponding trigger symbols while the first feature first frenzy mode is active (in which the second amount is larger than the first amount), each feature symbol of the first type may include either the first amount of corresponding trigger symbols or the second amount of corresponding trigger symbols while the first feature second mode is active, and the first feature first collection goal may be met when a first cumulative number of the trigger symbols has been displayed in the feature symbols of the first type in base game plays using the base game GUI since the first collection meter was last initialized. The one or more memory devices may further store additional instructions that, when executed by the one or more processors, further cause the one or more processors to cause the base game GUI to display, while the first feature frenzy mode is active, a first feature first frenzy mode timer configured to indicate how long until the first frenzy mode deactivates.

In some implementations, the first amount of corresponding trigger symbols may be one trigger symbol and the second amount of corresponding trigger symbols may be two trigger symbols.

In some implementations, the one or more memory devices may store further computer-executable instructions which, when executed by the one or more processors, cause the one or more processors to cause the base game GUI to transition to a bonus game GUI for a bonus game responsive to occurrence of a base game play in which at least a first predetermined number of the trigger symbols is displayed. In such implementations, the bonus game GUI may include the array of symbol positions and at least the feature symbols displayed in the symbol positions in the array of symbol positions in that base game play. The computer-executable instructions, when executed by the one or more processors, may also cause the one or more processors to cause, for each bonus game play using the bonus game GUI, new selections of the symbols to be displayed in the symbol positions that do not already display feature symbols, and to also cause the bonus game to conclude and the bonus game GUI to transition back to the base game GUI responsive to either a second predetermined number of the trigger symbols being displayed as a result of a bonus game play or a number of bonus game plays remaining reaching zero. The number of bonus game plays remaining may initially be set to a threshold amount of bonus game plays remaining in association with the base game GUI being caused to transition to the bonus game GUI, may be decremented by one for each bonus game play that does not result in any feature symbols being displayed in symbol positions that did not display a feature symbol immediately prior to that bonus game play, and may be reset to the threshold amount of bonus game plays remaining responsive to a bonus game play in which one or more of the symbol positions not displaying one of the feature symbols prior to that bonus game play is caused to display one of the feature symbols as a result of that bonus game play.

In some such implementations, the first feature first predetermined cumulative time period may not include time periods in which the bonus game GUI is displayed.

In some alternative or additional such implementations, the symbols from which the symbols that are newly displayed in bonus game plays may be drawn may also include at least one symbol that is an expansion symbol. In such implementations, the one or more memory devices may store further computer-executable instructions which, when executed by the one or more processors, cause the one or more processors to cause additional symbol positions to be added to the array of symbol positions responsive to display of the expansion symbol in one of the symbol positions as a result of one of the bonus game plays and for the expansion symbol to then be replaced by a feature symbol, and the second predetermined number may be equal to a maximum number of the symbol positions in the array of symbol positions achievable during play of the bonus game.

In some alternative or additional such implementations, the first collection meter may further indicate progress towards meeting a first feature second collection goal, and the one or more memory devices may further store additional computer-executable instructions which, when executed by the one or more processors, cause the one or more processors to cause the first feature second mode to be deactivated responsive to the first feature second collection goal being met, cause a first feature second frenzy mode to be activated responsive to the first feature second collection goal being met and deactivated after being active for a first feature second predetermined cumulative time period, and cause a first feature third mode to be activated responsive to deactivation of the first feature second frenzy mode. In such implementations, each feature symbol of the first type may include only a third amount of corresponding trigger symbols while the first feature second frenzy mode is active (in which the third amount is larger than the second amount), and each feature symbol of the first type may include either the first amount of corresponding trigger symbols or the third amount of corresponding trigger symbols while the first feature third mode is active. In such implementations. The one or more memory devices may further store additional instructions that, when executed by the one or more processors, further cause the one or more processors to cause the base game GUI to display, while the first feature second frenzy mode is active, a first feature second frenzy mode timer configured to indicate how long until the first feature second frenzy mode deactivates.

In some such implementations, the first amount of corresponding trigger symbols may be one trigger symbol, the second amount of corresponding trigger symbols may be two trigger symbols, and the third amount of corresponding trigger symbols may be three trigger symbols.

In some additional or alternative such implementations, the first feature second predetermined cumulative time period may not include time periods in which the bonus game GUI is displayed.

In some other additional or alternative such implementations, the base game GUI may further include a second collection meter indicating progress towards meeting a second feature first collection goal, the feature symbols may further include feature symbols of a second type, and the one or more memory devices may further store additional computer-executable instructions which, when executed by the one or more processors, cause the one or more processors to cause a second feature first mode to be activated responsive to initialization of the second collection meter and deactivated responsive to the second feature first collection goal being met, cause a second feature first frenzy mode to be activated responsive to the second feature first collection goal being met and deactivated after being active for a second feature first predetermined cumulative time period, and cause a second feature second mode to be activated responsive to deactivation of the second feature first frenzy mode. In such implementations, each feature symbol of the second type may include the first amount of corresponding trigger symbols and a corresponding value indication, each feature symbol of the second type may not be associated with an instant award status while the second feature first mode is active, each feature symbol of the second type may be associated with the instant award status while the second feature first frenzy mode is active, each feature symbol of the second type may either be associated with the instant award status or not associated with the instant award status while the second feature second mode is active, and the second feature first collection goal may be met when a second feature first cumulative number of the trigger symbols has been displayed in the feature symbols of the second type in base game plays using the base game GUI since the second collection meter was last initialized. The one or more memory devices may further store additional instructions that, when executed by the one or more processors, further cause the one or more processors to cause, for each of the feature symbols of the second type that is associated with the instant award status and displayed in one of the symbol positions, a value indicated by the corresponding value indication for that feature symbol of the second type to be added to a credit meter responsive to display of that feature symbol of the second type.

In some such implementations, the second feature first predetermined cumulative time period may not include time periods in which the bonus game GUI is displayed.

In some alternative such implementations, the second collection meter may further indicate progress towards meeting a second feature second collection goal, and the one or more memory devices may further store additional computer-executable instructions which, when executed by the one or more processors, cause the one or more processors to cause the second feature second mode to be deactivated responsive to the second feature second collection goal being met, cause a second feature second frenzy mode to be activated responsive to the second feature second collection goal being met and deactivated after being active for a second feature second predetermined cumulative time period, and cause a second feature third mode to be activated responsive to deactivation of the second feature second frenzy mode. In such an implementation, each feature symbol of the second type may be associated with the instant award status while the second feature second frenzy mode is active, and each feature symbol of the second type may either be associated with the instant award status or not associated with the instant award status while the second feature third mode is active. The one or more memory devices may further store additional instructions that, when executed by the one or more processors, further cause the one or more processors to cause, for each of the feature symbols of the second type that is associated with the instant award status and displayed in one of the symbol positions while the second feature second frenzy mode or the second feature third mode are active, the value indicated by the corresponding value indication for that feature symbol of the second type to be multiplied by a multiplier and then added to the credit meter responsive to display of that feature symbol of the second type.

In some such implementations, the second feature second predetermined cumulative time period may not include time periods in which the bonus game GUI is displayed.

In some implementations, one or more non-transitory, computer-readable media may be provided that store computer-executable instructions which, when executed by one or more processors, cause the one or more processors to cause a base game GUI to be displayed on one or more displays, the base game GUI including an array of symbol positions and a first collection meter indicating progress towards meeting a first feature first collection goal, cause a first feature first mode to be activated responsive to initialization of the first collection meter and deactivated responsive to the first feature first collection goal being met, cause a first feature first frenzy mode to be activated responsive to the first feature first collection goal being met and deactivated after being active for a first feature first predetermined cumulative time period, cause a first feature second mode to be activated responsive to deactivation of the first feature first frenzy mode, and cause, for each base game play using the base game GUI, symbols to be displayed in the symbol positions. The symbols displayed in one or more of the symbol positions for each base game play may each be drawn from symbols including feature symbols and non-feature symbols, the feature symbols may at least include feature symbols of a first type, each feature symbol of the first type may include only a first amount of corresponding trigger symbols while the first feature first mode is active, each feature symbol of the first type may include only a second amount of corresponding trigger symbols while the first feature first frenzy mode is active (with the second amount being larger than the first amount), each feature symbol of the first type may include either the first amount of corresponding trigger symbols or the second amount of corresponding trigger symbols while the first feature second mode is active, and the first feature first collection goal may be met when a first cumulative number of the trigger symbols has been displayed in the feature symbols of the first type in base game plays using the base game GUI since the first collection meter was last initialized. The one or more non-transitory, computer-readable media may further store additional instructions that, when executed by the one or more processors, further cause the one or more processors to cause the base game GUI to display, while the first feature frenzy mode is active, a first feature first frenzy mode timer configured to indicate how long until the first frenzy mode deactivates.

In some such implementations, the first amount of corresponding trigger symbols may be one trigger symbol and the second amount of corresponding trigger symbols may be two trigger symbols.

In some additional or alternative such implementations, the one or more non-transitory, computer-readable media may further store additional computer-executable instructions which, when executed by the one or more processors, cause the one or more processors to cause the base game GUI to transition to a bonus game GUI for a bonus game responsive to occurrence of a base game play in which at least a first predetermined number of the trigger symbols is displayed (in which the bonus game GUI includes the array of symbol positions and at least the feature symbols displayed in the symbol positions in the array of symbol positions in that base game play), cause, for each bonus game play using the bonus game GUI, new selections of the symbols to be displayed in the symbol positions that do not already display feature symbols, and cause the bonus game to conclude and the bonus game GUI to transition back to the base game GUI responsive to either a second predetermined number of the trigger symbols being displayed as a result of a bonus game play or a number of bonus game plays remaining reaching zero. The number of bonus game plays remaining may initially be set to a threshold amount of bonus game plays remaining in association with the base game GUI being caused to transition to the bonus game GUI, may be decremented by one for each bonus game play that does not result in any feature symbols being displayed in symbol positions that did not display a feature symbol immediately prior to that bonus game play, and may be reset to the threshold amount of bonus game plays remaining responsive to a bonus game play in which one or more of the symbol positions not displaying one of the feature symbols prior to that bonus game play is caused to display one of the feature symbols as a result of that bonus game play.

In some such implementations, the first feature first predetermined cumulative time period may not include time periods in which the bonus game GUI is displayed.

In some additional or alternative such implementations, the symbols from which the symbols that are newly displayed in bonus game plays are drawn may also include at least one symbol that is an expansion symbol, and the one or more non-transitory, computer-readable media may store further computer-executable instructions which, when executed by the one or more processors, cause the one or more processors to cause additional symbol positions to be added to the array of symbol positions responsive to display of the expansion symbol in one of the symbol positions as a result of one of the bonus game plays and for the expansion symbol to then be replaced by a feature symbol. In such implementations, the second predetermined number may be equal to a maximum number of the symbol positions in the array of symbol positions achievable during play of the bonus game.

In some further additional or alternative such implementations, the first collection meter may further indicate progress towards meeting a first feature second collection goal, and the one or more non-transitory, computer-readable media may further store additional computer-executable instructions which, when executed by the one or more processors, cause the one or more processors to cause the first feature second mode to be deactivated responsive to the first feature second collection goal being met, cause a first feature second frenzy mode to be activated responsive to the first feature second collection goal being met and deactivated after being active for a first feature second predetermined cumulative time period, and cause a first feature third mode to be activated responsive to deactivation of the first feature second frenzy mode. Each feature symbol of the first type may include only a third amount of corresponding trigger symbols while the first feature second frenzy mode is active (the third amount may be larger than the second amount), and each feature symbol of the first type may include either the first amount of corresponding trigger symbols or the third amount of corresponding trigger symbols while the first feature third mode is active. The one or more non-transitory, computer-readable media may store further computer-executable instructions which, when executed by the one or more processors, cause the one or more processors to cause the base game GUI to display, while the first feature second frenzy mode is active, a first feature second frenzy mode timer configured to indicate how long until the first feature second frenzy mode deactivates.

In some such implementations, the first amount of corresponding trigger symbols may be one trigger symbol, the second amount of corresponding trigger symbols may be two trigger symbols, and the third amount of corresponding trigger symbols may be three trigger symbols.

In some alternative or additional such implementations, the first feature second predetermined cumulative time period may not include time periods in which the bonus game GUI is displayed.

In some implementations, the base game GUI may further include a second collection meter indicating progress towards meeting a second feature first collection goal, the feature symbols may further include feature symbols of a second type, and the one or more non-transitory, computer-readable media may further store additional computer-executable instructions which, when executed by the one or more processors, cause the one or more processors to cause a second feature first mode to be activated responsive to initialization of the second collection meter and deactivated responsive to the second feature first collection goal being met, cause a second feature first frenzy mode to be activated responsive to the second feature first collection goal being met and deactivated after being active for a second feature first predetermined cumulative time period, and cause a second feature second mode to be activated responsive to deactivation of the second feature first frenzy mode. Each feature symbol of the second type may include the first amount of corresponding trigger symbols and a corresponding value indication, each feature symbol of the second type may not be associated with an instant award status while the second feature first mode is active, each feature symbol of the second type may be associated with the instant award status while the second feature first frenzy mode is active, each feature symbol of the second type may either be associated with the instant award status or not associated with the instant award status while the second feature second mode is active, and the second feature first collection goal may be met when a second feature first cumulative number of the trigger symbols has been displayed in the feature symbols of the second type in base game plays using the base game GUI since the second collection meter was last initialized. The one or more non-transitory, computer-readable media may further store additional computer-executable instructions which, when executed by the one or more processors, cause the one or more processors to cause, for each of the feature symbols of the second type that is associated with the instant award status and displayed in one of the symbol positions, a value indicated by the corresponding value indication for that feature symbol of the second type to be added to a credit meter responsive to display of that feature symbol of the second type.

In some such implementations, the second feature first predetermined cumulative time period may not include time periods in which the bonus game GUI is displayed.

In some alternative or additional such implementations, the second collection meter may further indicate progress towards meeting a second feature second collection goal, and the one or more non-transitory computer-readable media further store additional computer-executable instructions which, when executed by the one or more processors, cause the one or more processors to cause the second feature second mode to be deactivated responsive to the second feature second collection goal being met, cause a second feature second frenzy mode to be activated responsive to the second feature second collection goal being met and deactivated after being active for a second feature second predetermined cumulative time period, and cause a second feature third mode to be activated responsive to deactivation of the second feature second frenzy mode. Each feature symbol of the second type may be associated with the instant award status while the second feature second frenzy mode is active, and each feature symbol of the second type may either be associated with the instant award status or not be associated with the instant award status while the second feature third mode is active. The one or more non-transitory, computer-readable media may further store additional computer-executable instructions which, when executed by the one or more processors, cause the one or more processors to cause, for each of the feature symbols of the second type that is associated with the instant award status and displayed in one of the symbol positions while the second feature second frenzy mode or the second feature third mode are active, the value indicated by the corresponding value indication for that feature symbol of the second type to be multiplied by a multiplier and then added to the credit meter responsive to display of that feature symbol of the second type.

In some such implementations, the second feature second predetermined cumulative time period may not include time periods in which the bonus game GUI is displayed.

In some implementations, a method may be provided that may include causing, by one or more processors, a base game GUI to be displayed on one or more displays, the base game GUI including an array of symbol positions and a first collection meter indicating progress towards meeting a first feature first collection goal. The method may further include causing, by the one or more processors, a first feature first mode to be activated responsive to initialization of the first collection meter and deactivated responsive to the first feature first collection goal being met, causing, by the one or more processors, a first feature first frenzy mode to be activated responsive to the first feature first collection goal being met and deactivated after being active for a first feature first predetermined cumulative time period, causing, by the one or more processors, a first feature second mode to be activated responsive to deactivation of the first feature first frenzy mode, and causing, by the one or more processors and for each base game play using the base game GUI, symbols to be displayed in the symbol positions. The symbols displayed in one or more of the symbol positions for each base game play may each be drawn from symbols including feature symbols and non-feature symbols, the feature symbols at least may include feature symbols of a first type, each feature symbol of the first type may include only a first amount of corresponding trigger symbols while the first feature first mode is active, each feature symbol of the first type may include only a second amount of corresponding trigger symbols while the first feature first frenzy mode is active (with the second amount being larger than the first amount), each feature symbol of the first type may include either the first amount of corresponding trigger symbols or the second amount of corresponding trigger symbols while the first feature second mode is active, and the first feature first collection goal may be met when a first cumulative number of the trigger symbols has been displayed in the feature symbols of the first type in base game plays using the base game GUI since the first collection meter was last initialized. The method may further include causing, by the one or more processors, the base game GUI to display, while the first feature frenzy mode is active, a first feature first frenzy mode timer configured to indicate how long until the first frenzy mode deactivates.

In some implementations, the first amount of corresponding trigger symbols may be one trigger symbol and the second amount of corresponding trigger symbols may be two trigger symbols.

In some implementations, the method may further include causing, by the one or more processors, the base game GUI to transition to a bonus game GUI for a bonus game responsive to occurrence of a base game play in which at least a first predetermined number of the trigger symbols is displayed (in which the bonus game GUI includes the array of symbol positions and at least the feature symbols displayed in the symbol positions in the array of symbol positions in that base game play), causing, by the one or more processors and for each bonus game play using the bonus game GUI, new selections of the symbols to be displayed in the symbol positions that do not already display feature symbols, and causing, by the one or more processors, the bonus game to conclude and the bonus game GUI to transition back to the base game GUI responsive to either a second predetermined number of the trigger symbols being displayed as a result of a bonus game play or a number of bonus game plays remaining reaching zero. The number of bonus game plays remaining may initially be set to a threshold amount of bonus game plays remaining in association with the base game GUI being caused to transition to the bonus game GUI, may be decremented by one for each bonus game play that does not result in any feature symbols being displayed in symbol positions that did not display a feature symbol immediately prior to that bonus game play, and may be reset to the threshold amount of bonus game plays remaining responsive to a bonus game play in which one or more of the symbol positions not displaying one of the feature symbols prior to that bonus game play is caused to display one of the feature symbols as a result of that bonus game play.

In some such implementations, the first feature first predetermined cumulative time period may not include time periods in which the bonus game GUI is displayed.

In some implementations, the symbols from which the symbols that are newly displayed in bonus game plays are drawn may also include at least one symbol that is an expansion symbol, the method may further include causing, by the one or more processors, additional symbol positions to be added to the array of symbol positions responsive to display of the expansion symbol in one of the symbol positions as a result of one of the bonus game plays and for the expansion symbol to then be replaced by a feature symbol, and the second predetermined number may be equal to a maximum number of the symbol positions in the array of symbol positions achievable during play of the bonus game.

In some implementations, the first collection meter may further indicate progress towards meeting a first feature second collection goal, and the method may further include causing, by the one or more processors, the first feature second mode to be deactivated responsive to the first feature second collection goal being met, causing, by the one or more processors, a first feature second frenzy mode to be activated responsive to the first feature second collection goal being met and deactivated after being active for a first feature second predetermined cumulative time period, and causing, by the one or more processors, a first feature third mode to be activated responsive to deactivation of the first feature second frenzy mode. Each feature symbol of the first type includes only a third amount of corresponding trigger symbols while the first feature second frenzy mode is active (the third amount may be larger than the second amount), and each feature symbol of the first type may include either the first amount of corresponding trigger symbols or the third amount of corresponding trigger symbols while the first feature third mode is active. The method may further include causing, by the one or more processors, the base game GUI to display, while the first feature second frenzy mode is active, a first feature second frenzy mode timer configured to indicate how long until the first feature second frenzy mode deactivates.

In some such implementations, the first amount of corresponding trigger symbols may be one trigger symbol, the second amount of corresponding trigger symbols may be two trigger symbols, and the third amount of corresponding trigger symbols may be three trigger symbols.

In some additional or alternative such implementations, the first feature second predetermined cumulative time period may not include time periods in which the bonus game GUI is displayed.

In some implementations, the base game GUI may further include a second collection meter indicating progress towards meeting a second feature first collection goal, the feature symbols may further include feature symbols of a second type, and the method may further include causing, by the one or more processors, a second feature first mode to be activated responsive to initialization of the second collection meter and deactivated responsive to the second feature first collection goal being met, causing, by the one or more processors, a second feature first frenzy mode to be activated responsive to the second feature first collection goal being met and deactivated after being active for a second feature first predetermined cumulative time period, and causing, by the one or more processors, a second feature second mode to be activated responsive to deactivation of the second feature first frenzy mode. Each feature symbol of the second type may include the first amount of corresponding trigger symbols and a corresponding value indication, each feature symbol of the second type may not be associated with an instant award status while the second feature first mode is active, each feature symbol of the second type may be associated with the instant award status while the second feature first frenzy mode is active, each feature symbol of the second type may either be associated with the instant award status or not associated with the instant award status while the second feature second mode is active, and the second feature first collection goal may be met when a second feature first cumulative number of the trigger symbols has been displayed in the feature symbols of the second type in base game plays using the base game GUI since the second collection meter was last initialized. The method may further include causing, by the one or more processors and for each of the feature symbols of the second type that is associated with the instant award status and displayed in one of the symbol positions, a value indicated by the corresponding value indication for that feature symbol of the second type to be added to a credit meter responsive to display of that feature symbol of the second type.

In some implementations of the method, the second feature first predetermined cumulative time period may not include time periods in which the bonus game GUI is displayed.

In some alternative or additional such implementations, the second collection meter may further indicate progress towards meeting a second feature second collection goal, and the method may further include causing, by the one or more processors, the second feature second mode to be deactivated responsive to the second feature second collection goal being met, causing, by the one or more processors, a second feature second frenzy mode to be activated responsive to the second feature second collection goal being met and deactivated after being active for a second feature second predetermined cumulative time period, and causing, by the one or more processors, a second feature third mode to be activated responsive to deactivation of the second feature second frenzy mode. Each feature symbol of the second type may be associated with the instant award status while the second feature second frenzy mode is active, and each feature symbol of the second type may either be associated with the instant award status or not associated with the instant award status while the second feature third mode is active. The method may further include causing, by the one or more processors and for each of the feature symbols of the second type that is associated with the instant award status and displayed in one of the symbol positions while the second feature second frenzy mode or the second feature third mode are active, the value indicated by the corresponding value indication for that feature symbol of the second type to be multiplied by a multiplier and then added to the credit meter responsive to display of that feature symbol of the second type.

In some such implementations, the second feature second predetermined cumulative time period may not include time periods in which the bonus game GUI is displayed.

### BRIEF DESCRIPTION OF THE DRAWINGS

FIG. 1 is an exemplary diagram showing several EGMs networked with various gaming-related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 depicts a GUI for a base game that may be used to implement the concepts discussed herein.

FIG. 5 depicts several collection meter examples.

FIG. 6 depicts various types of symbols that may be displayed in base game and bonus game outcomes in the concepts discussed herein.

FIGS. 7 through 24 depict various states of the base game GUI of FIG. 4 or of a bonus game that is triggerable from that base game.

The FIGURES are provided for the purpose of providing examples and clarity regarding various aspects of this disclosure and are not intended to be limiting.

### DETAILED DESCRIPTION

The following discussion provides overall context for gaming machines that may be used to implement a feature game mechanic such as is described above and later herein. Following this overview, a more focused discussion of the feature game mechanic concepts discussed above is provided.

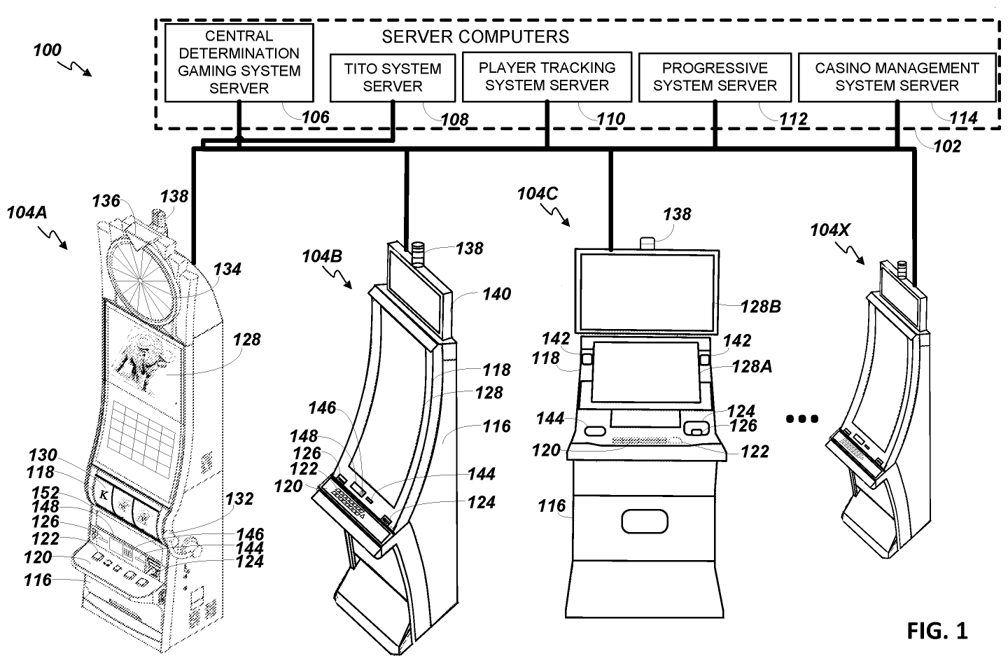

FIG. 1 illustrates several different models of EGMs which may be networked to various gaming-related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

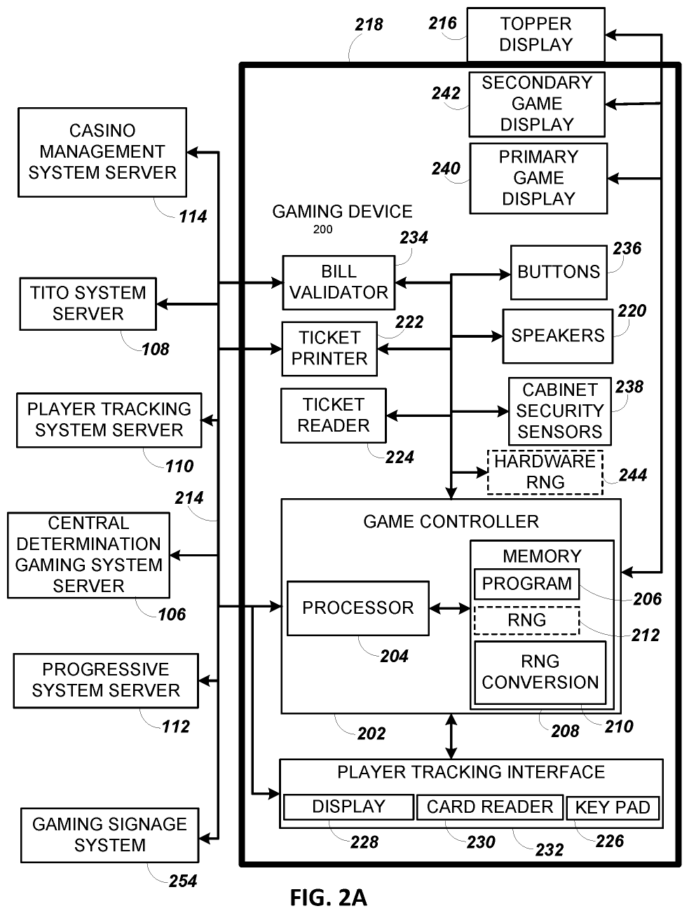

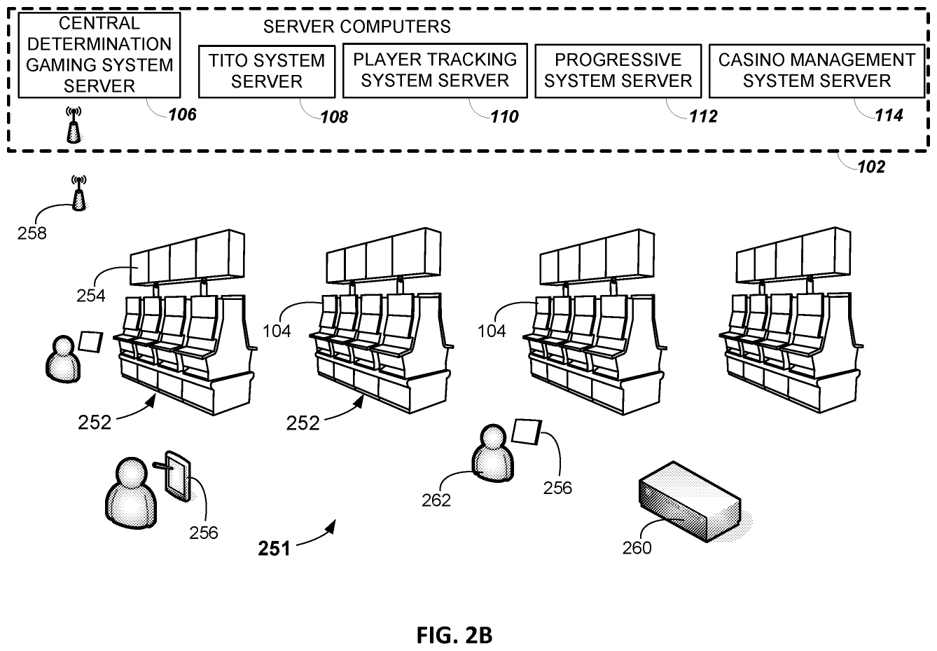

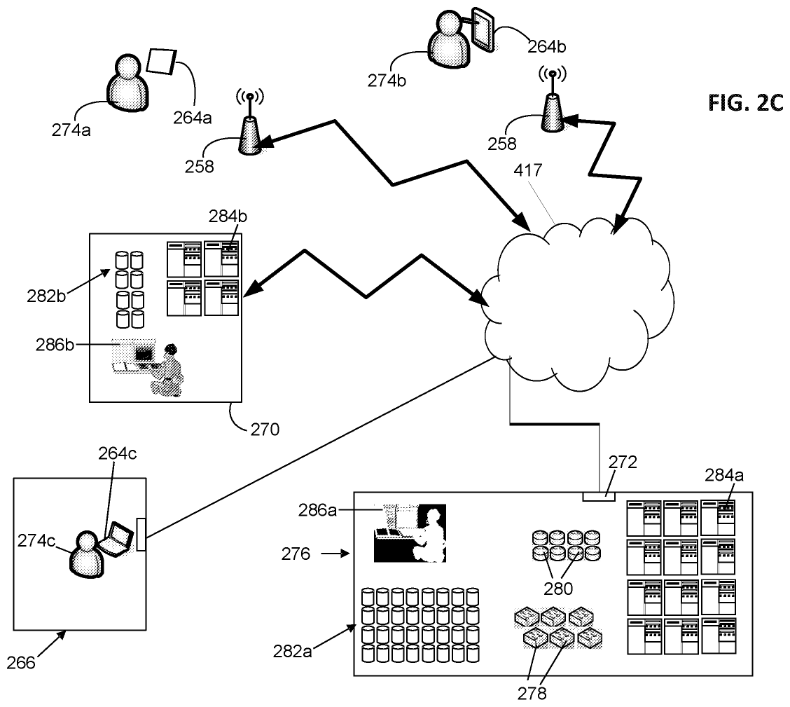

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 may, for example, be a remote gaming server (RGS) or similar system in some implementations. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

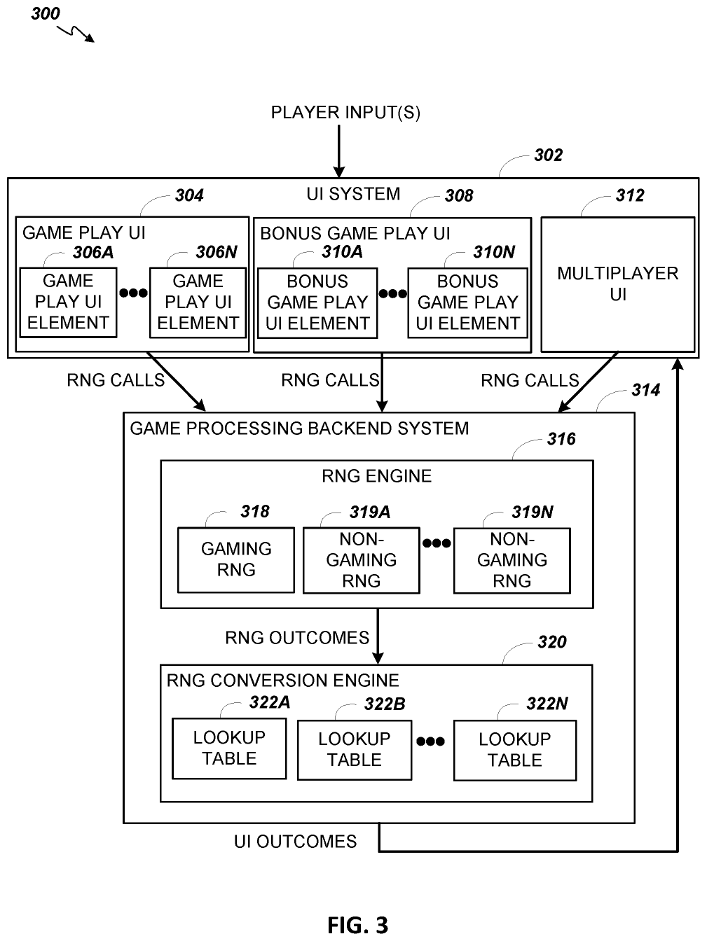

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

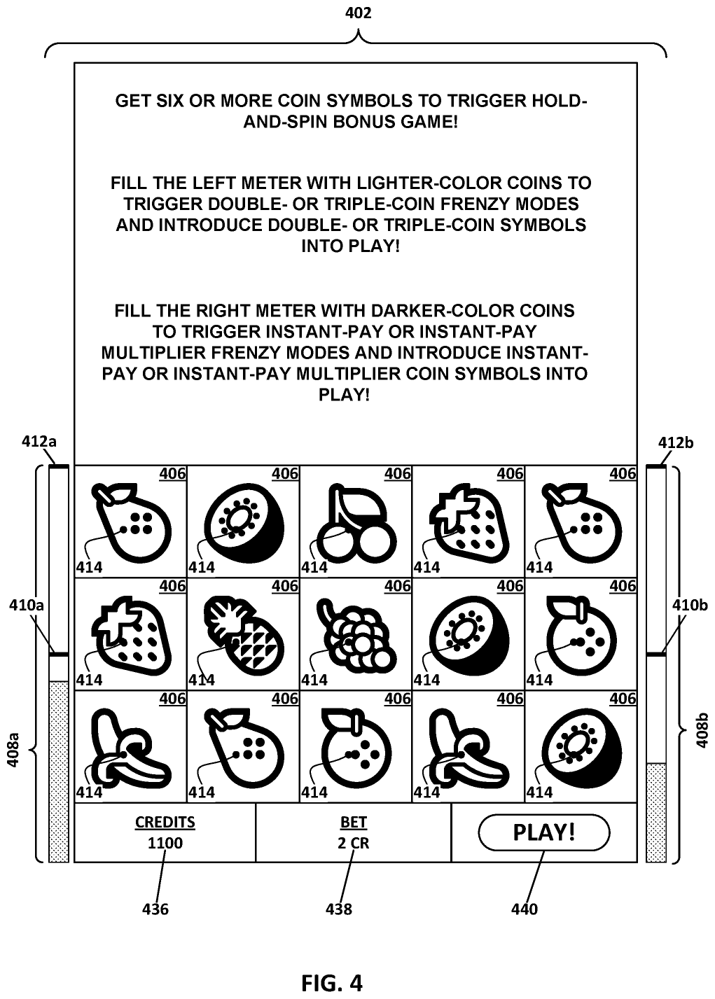

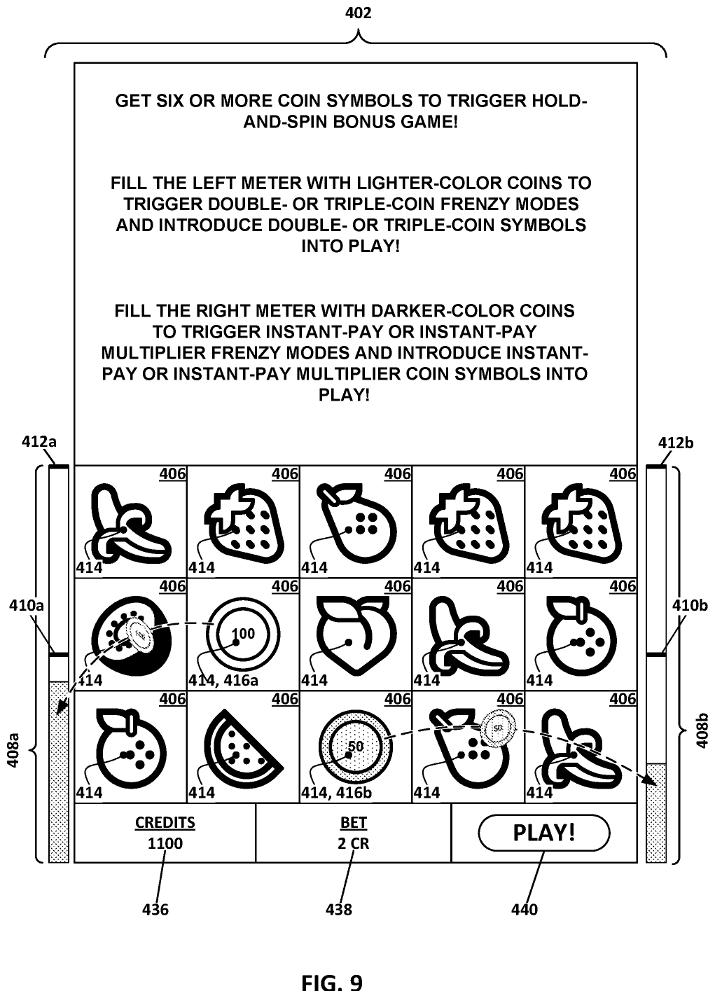

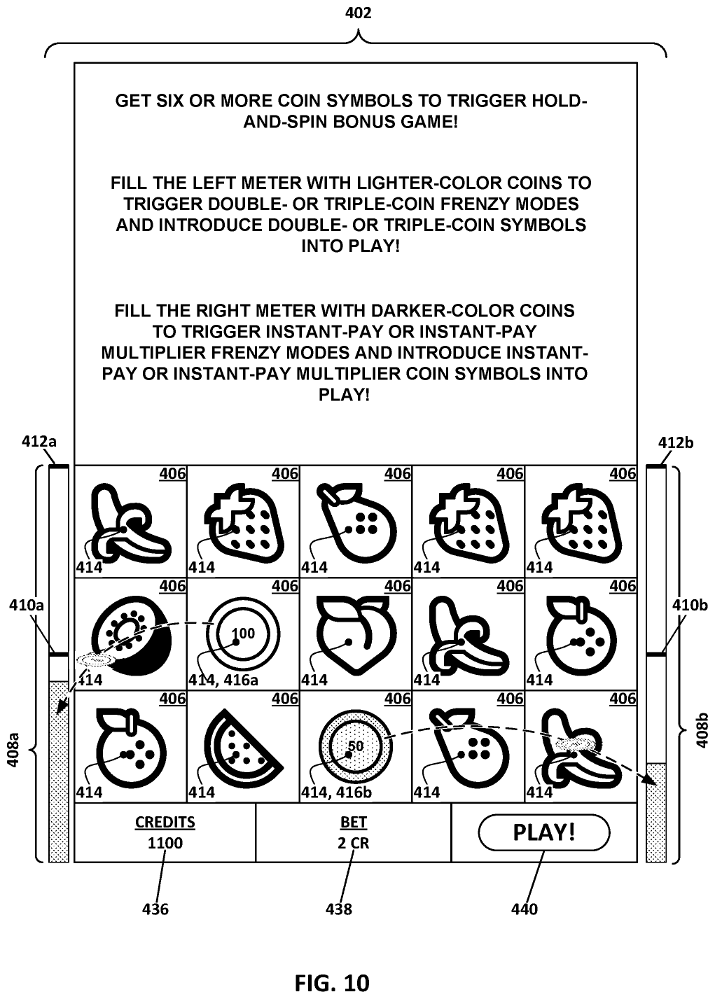

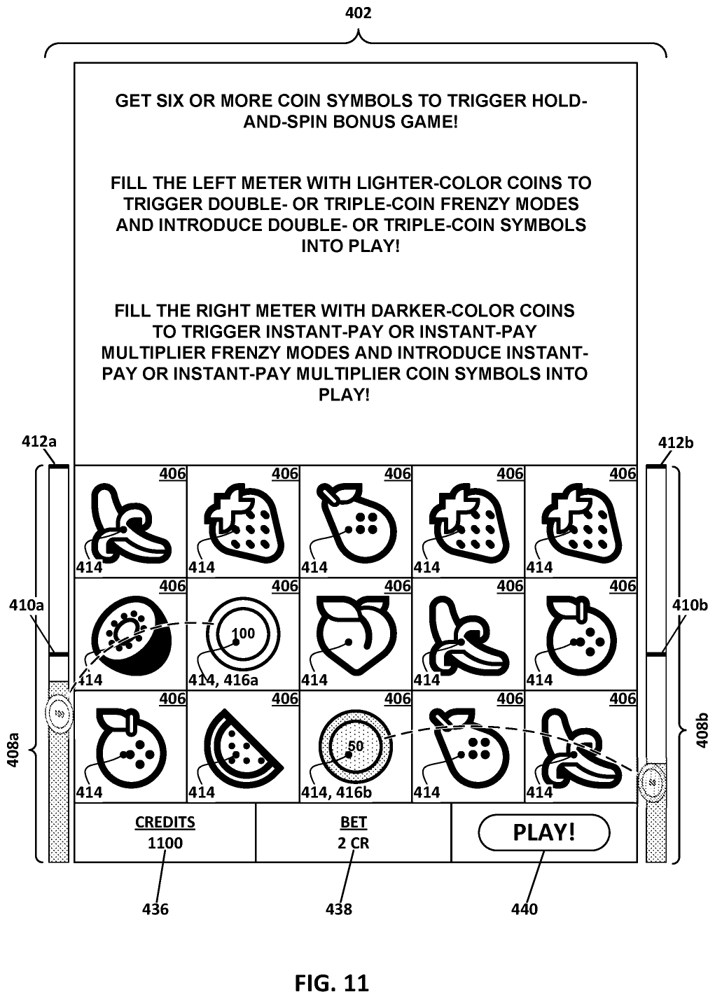

FIGS. 4 and 7 through 24 depict various states of a graphical user interface (GUI) for a base game or a bonus game that may be used to implement upgradeable feature symbols and associated collection meters, as discussed earlier above.

FIG. 4 depicts a base game GUI 402. The base game GUI 402 includes an array of symbol positions 406 in which symbols 414 may be displayed. The array of symbol positions in this example is an array with five columns and three rows of symbol positions 406 (a 5×3 array), but it will be understood that other arrays of symbol positions 406 may be used as well, e.g., a 4×3 array, a 3×3 array, a 6×3 array, a 6×4 array, etc.) in other implementations. Additionally, it will be understood that such arrays of symbol positions 406 need not be rectangular arrays, but may also be arrangements of symbol positions 406 in which there may be different numbers of symbol positions in some columns and/or rows than in other columns and/or rows, e.g., an array of symbol positions 406 in which there are five columns of symbol positions 406, with the middle three columns of symbol positions 406 having four rows of symbol positions 406 and the outer two columns of symbol positions 406 having three rows of symbol positions 406.

Generally speaking, each play of the base game using the base game GUI 402 will result in various symbols 414 being selected, e.g., via random selection, being displayed in the symbol positions 406. As in a typical slot machine, patterns of symbols 414 along, for example, paylines that include one symbol position from each column, may be evaluated to determine if there are any such patterns that satisfy a win condition. If so, then an amount associated with that win condition may be added to a score or credit meter for the base game.

As shown in FIG. 4, the symbols 414 that are shown are all “non-feature” symbols. It will be understood that in these example Figures, all symbols 414 that display icons or images of fruit are non-feature symbols. Additionally, such non-feature symbols 414 may be called out with callouts 414 without additional callouts.

The base game GUI 402 may also include a first collection meter 408a and a second collection meter 408b. The first collection meter 408a may indicate a player's progress towards completing a first feature first collection goal 410a and towards completing a first feature second collection goal 412a. Similarly, the second collection meter 408b may indicate a player's progress towards completing a second feature first collection goal 410b and towards completing a second feature second collection goal 412b. As shown in FIG. 4, the first collection meter 408a and the second collection meter 408b are both vertical bar indicators that indicate, e.g., by the amount of shaded fill therein, how close the player is to achieving the first and second collection goals 410 and 412 associated therewith. Put another way, the percentage of the height (or width, if the collection meter has a long axis that is horizontal) of the collection meter that is filled with a different color or otherwise differentiated from the remainder of the collection meter is made to align with the ratio of the player's current level of progress with respect to the goal to the actual goal amount.

In FIG. 4, the first collection meter 408a shows that the player is approximately 90% of the way to completing the first feature first collection goal 410a and about 45% of the way to completing the first feature second collection goal 412a. Similarly, the second collection meter 408b shows that the player is approximately 50% of the way to completing the second feature first collection goal 410b and about 45% of the way to completing the second feature second collection goal 412b.

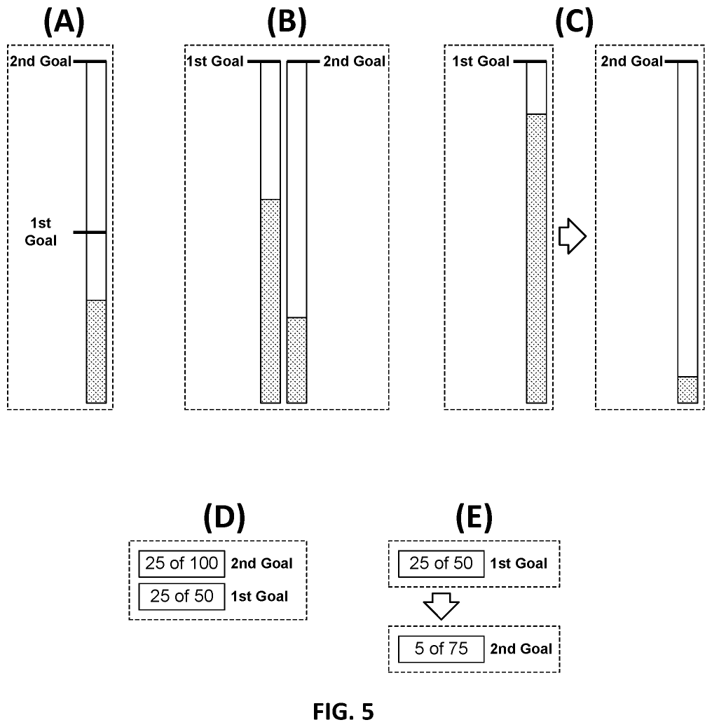

It will be appreciated that the first collection meter 408a and the second collection meter 408b may both be provided in a number of formats, and are not limited to the specific examples depicted in FIG. 4. FIG. 5 depicts several non-limiting example formats for collection meters. For example, the example (A) in FIG. 5 is similar to the first collection meter 408a and the second collection meter 408b, e.g., it has a vertical bar that is filled with a graphically distinct fill that extends from the bottom end of the bar up to a point that where the distance between that point and the bottom of the bar divided by the distance from the top of the bar to the bottom of the bar is proportionate to the total number of trigger symbols displayed since the collection meter was last initialized divided by the total number of trigger symbols that need to have been displayed since the collection meter was last initialized in order to meet the second collection goal. The first collection goal may be indicated by a mark on the bar that is positioned at a distance from the bottom of the bar that is proportionate, relative to the length of the bar, to the first collection goal divided by the second collection goal.

In example (B) of FIG. 5, there are two bars in the collection meter, each independently tracking progress towards a different collection goal. Thus, when one or more triggering symbols are displayed and the collection meter in (B) is updated, both shaded portions that are depicted may move up at the same time.

In example (C) of FIG. 5, the collection meter depicted is similar to example (A), but only shows one collection goal at a time—when that collection goal is met, the progress indicated may be reset to reflect progress made in displaying the additional trigger symbols needed to meet the next collection goal.

Example (D) of FIG. 5 depicts collection meters which are numeric/textual in nature, i.e., they use numbers and/or text to convey progress towards a collection goal instead of using relative sizes of graphical objects, e.g., bars/fill. Thus, in example (D), the number of trigger symbols displayed thus far (25) is shown compared to the number of trigger symbols needed to meet the first collection goal (50) and the second collection goal (100).

Example (E) of FIG. 5 is similar to example D, except the collection meter only shows one collection goal at a time, similar to the example (C) discussed above, but in textual/numeric format.

The base game GUI 402 may also include a credit meter 436 (or score meter), a bet level indicator 438, and a play button 440. The bet level indicator 438 may, for example, indicate an amount of credits (or points) that will be debited for each play of the base game, which may be initiated by the player by pressing the play button 440 (which may be, for example, a touch-screen control displayed on a touch-sensitive display, as shown, or may be a physical button).

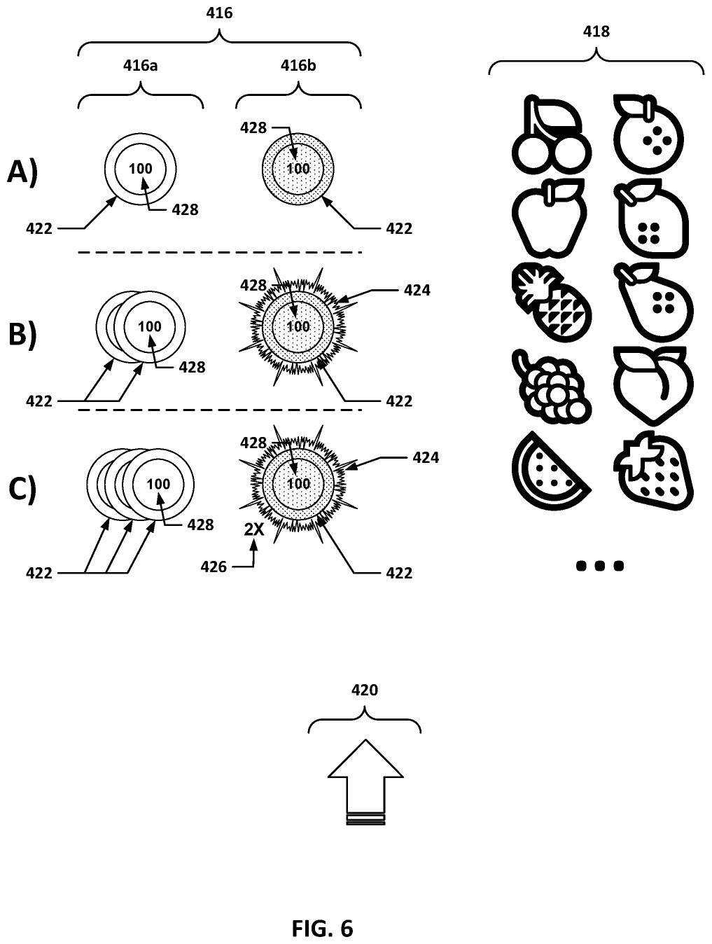

The symbols 414 that are shown in the symbol positions 406 in the base game GUI 402 may be randomly selected from a plurality of different kinds of symbols. FIG. 6 provides examples of different kinds of symbols 414 that may be selected for display in the symbol positions 406. For example, some symbols 414 may be feature symbols 416 which may each include one or more trigger symbols 422 and a corresponding value indication or value indications 428. The value indication(s) 428 may, for each such feature symbol 416, give an indication of a value associated with the feature symbol 416.

In the present example base game GUI 402, there are two different types of the feature symbols 416—feature symbols of a first type 416a, and feature symbols of a second type 416b. The feature symbols of the first type 416a may, when displayed as part of a base game outcome, contribute towards meeting the first feature first and/or second collection goals 410a and 412a, whereas the feature symbols of the second type 416b may, when displayed as part of a base game outcome, contribute towards meeting the second feature first and/or second collection goals 410b and 412b.

The feature symbols of the first type 416a and the feature symbols of the second type 416b may have different variants, e.g., with varying levels of enhancement. For example, the feature symbols of the first type 416a and the feature symbols of the second type 416b designated (A) in FIG. 6 may be the “default” or “base” versions of those feature symbols 416, while the feature symbols of the first type 416a and the feature symbols of the second type 416b designated (B) in FIG. 6 are versions of those feature symbols 416 that have been enhanced, e.g., through inclusion of an extra trigger symbol 422 (with respect to the feature symbol of the first type 416a) or by having an “instant award” status associated therewith (with respect to the feature symbol of the second type 416b). Similarly, the feature symbols of the first type 416a and the feature symbols of the second type 416b designated (C) in FIG. 6 may be versions of the feature symbols of the first type 416a and the feature symbols of the second type 416b that have been enhanced to a greater extent than the versions (B) of those feature symbols 416. For example, the feature symbols of the first type 416a and the feature symbols of the second type 416b designated (C) in FIG. 6 may include an additional extra trigger symbol 422 (with respect to the feature symbol of the first type 416a) or by having a multiplier associated therewith (with respect to the feature symbol of the second type 416b). The (A) versions of the feature symbols of the first type 416a and the feature symbols of the second type 416b may be available initially for base game play, while the (B) and (C) versions of the feature symbols of the first type 416a and the feature symbols of the second type 416b may be unlocked for play by meeting the first feature and/or second feature first and/or second collection goals, as discussed earlier.

The value indication 428 for each feature symbol 416 provides an indication of how many credits or points may be awarded to a player responsive to display of such a feature symbol 416 under some circumstances, e.g., at the conclusion of the bonus game discussed previously or, if the feature symbol 416 has an “instant award” status, additionally at the time the feature symbol 416 is displayed. The value indication 428 may either explicitly indicate the exact amount that will be awarded or may, in conjunction with other characteristics of the feature symbol 416, indirectly or implicitly indicate the amount that will be awarded. For example, in FIG. 6, all six of the feature symbols 416 that are displayed have a value indication 428 of “100.” For the version (A) feature symbols of the first type 416a and feature symbols of the second type 416b, this reflects the amount that would be awarded in connection with either such feature symbol 416 if an award were to be provided due to the display of such a feature symbol 416. For the version (B) and (C) feature symbols of the first type 416a, the value indication 428 of “100” would be doubled and tripled, respectively, since the value indication 428 is shown as being the denomination of a trigger symbol 422 having the appearance of a coin, and in the (B) and (C) versions of the feature symbols of the first type 416a, there are two and three such trigger symbols 422, thus suggesting that one would receive two or three times the amount explicitly shown (the assumption being that the extra coin(s)/trigger symbol(s) 422 also have similar denominations, but those denominations are hidden behind the coin(s)/trigger symbol(s) that are foremost. Thus, the value indication of the (A) and (B) versions of the feature symbols of the first type 416a will be understood to actually be provided by a combination of the number “100” that is displayed and the graphics indicating the number of trigger symbols 422.

For the versions “B” and “C” of the feature symbols of the second type 416b, the value indication 428 that is shown explicitly indicates the exact amount that will be awarded. However, the version “C” of the feature symbols of the second type 416b is also associated with a multiplier, so the amount that would be awarded would be multiplied by the indicated multiplier, e.g., two, upon being awarded.

The symbols may also include non-feature symbols 418. As indicated previously, in this example, all fruit symbols are treated as non-feature symbols. Of course, any designated symbols may be non-feature symbols 418, and non-feature symbols 418 may include “normal” symbols (symbols that have no other function than to potentially form winning patterns in base game outcomes) as well as special symbols, e.g., wild symbols (that may act as any other symbol for the purpose of determining winning patterns), multiplier symbols (which may cause awards provided as a result of a base game play to be multiplied by the multiplier before being added to the player's credit or score meter, free play symbols (which may grant some number of “free” plays of the base game), etc. For the purposes of this disclosure and discussion, a non-feature symbol 418 may be generally understood to be a symbol 414 that cannot contribute towards completion of the first feature or second feature first or second collection goal and that is not a symbol 414 that would be “held” in bonus game play.

The expansion (or “grow”) symbol(s) 420, if used, may be a special type of symbol that may, for example, be displayed in bonus game outcomes and may, if displayed, potentially cause the array of symbol positions 406 displayed in the bonus game GUI to expand by one or more rows, up to a predetermined maximum size of the array of symbol positions 406. Once such an array expansion has been completed, the expansion symbol 420 in the array of symbol positions 406 may then be replaced with a feature symbol 416. The symbols 414 may also include other types of symbols as well, although such other types of symbols are not discussed here.

For convenience, symbols 414 that are called out in the Figures discussed below may be assumed to be non-feature symbols 418 unless indicated otherwise, e.g., via an additional callout or as clearly being a symbol 414 with a value indication 428 and/or a trigger symbol 422.

When symbols are selected for display in a base or bonus game outcome, they may be generally said to be drawn from a plurality of symbols 414 that include, for example, feature symbols 416 and non-feature symbols 418. Such a plurality of symbols 414 is to be understood to refer to any symbols 414 that may potentially be displayed in any of the symbol positions 406 in that base or bonus game outcome—even if some of those symbols may not be selectable for display in all of such symbol positions. For example, a base game GUI may be configured to display symbols in the leftmost and right most columns of symbol positions that are randomly selected from reel strips having only symbols A through W, but to also display symbols in the middle columns of symbol positions that are randomly selected from reel strips having only symbols D through Z. The plurality of symbols from which symbols for display in the symbol positions are drawn in such a game would, per the above understanding, thus include symbols A through Z—even though symbols A through C and X through Z would not be able to be selected at all for some symbol positions in such an outcome.

The base game GUI 402 also includes textual information on what will happen when various events occur within the base game. For example, getting a predetermined number (or more) of coin symbols (which are the trigger symbols 422 in this example) in a base game outcome will trigger a bonus game, e.g., a hold-and-spin game. In this example, the threshold number of trigger symbols 422 is six trigger symbols 422. Further textual information indicates that filling the first (left) or second (right) collection meters 408a and 408b, respectively, will trigger double- or triple-coin frenzy modes or trigger instant-pay or instant-pay multiplier frenzy modes, respectively, as well as unlocking enhanced states of the feature symbols 416 in later plays.

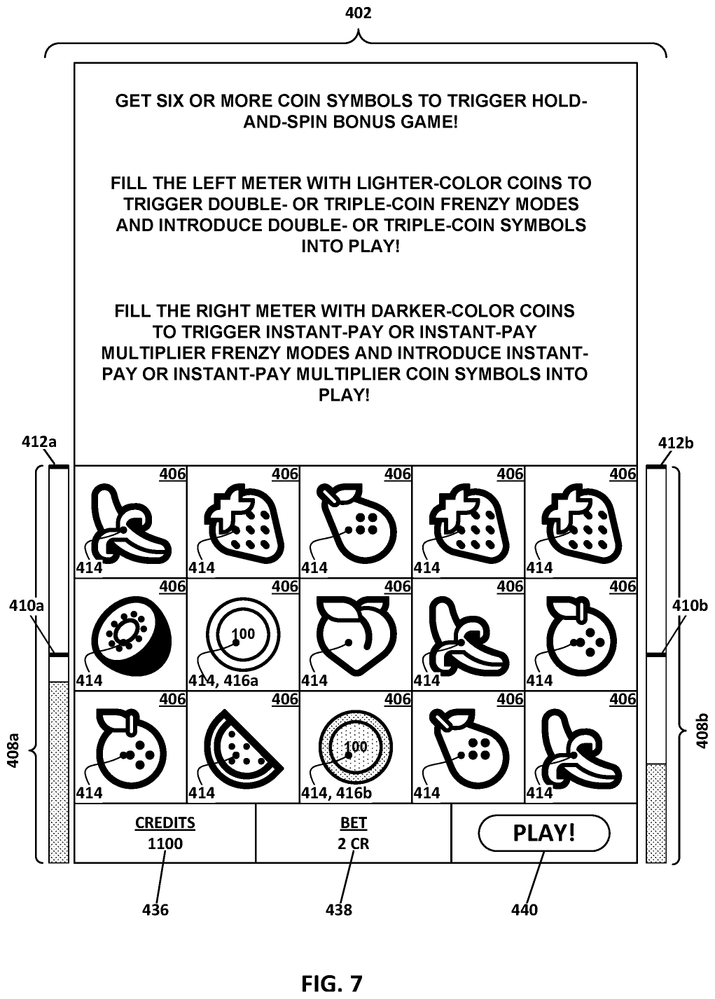

FIG. 7 depicts the base game GUI 402 after a play of the base game has occurred responsive to a touch input received by the play button 440. As can be seen, a new selection of symbols 414 has been made and caused to be displayed in the symbol positions 406 of the base game GUI 402 in order to provide a base game outcome responsive to such touch input. In this particular example base game play, non-feature symbols 418 have been displayed in all but two of the symbol positions 406. For example, a feature symbol of the first type 416a has been displayed in the symbol position 406 in the middle row of the second column of symbol positions 406 from the left, while a feature symbol of the second type 416b has been displayed in the middle symbol position 406 of the bottom row of symbol positions 406.

The display of the feature symbol of the first type 416a and/or the display of the feature symbol of the second type 416b in a base game outcome will cause the first collection meter 408a and/or the second collection meter 408b to be updated accordingly, e.g., to reflect inclusion of one or more trigger symbols 422 in the feature symbol of the first type 416a and/or the feature symbol of the second type 416b.

In some implementations, the updating of the first collection meter 408a and/or the second collection meter 408b may be presented in combination with an animation that clearly indicates which of the first collection meter 408a and the second collection meter 408b is being updated in response to the trigger symbol(s) 422 shown in each feature symbol of the first type 416a and/or the feature symbol of the second type 416b that is displayed in a particular base game outcome. For example, each trigger symbol 422 that is included in the feature symbol of the first type 416a and/or the feature symbol of the second type 416b that is shown, or a replica thereof, may be caused to move along a path from the feature symbol of the first type 416a and/or the feature symbol of the second type 416b that includes it to the respective first collection meter 408a or second collection meter 408b. In some such cases, the trigger symbol 422 that follows the path may also be caused to perform other movements as well, e.g., spin end over end, rotate about its center axis, grow/shrink, etc.

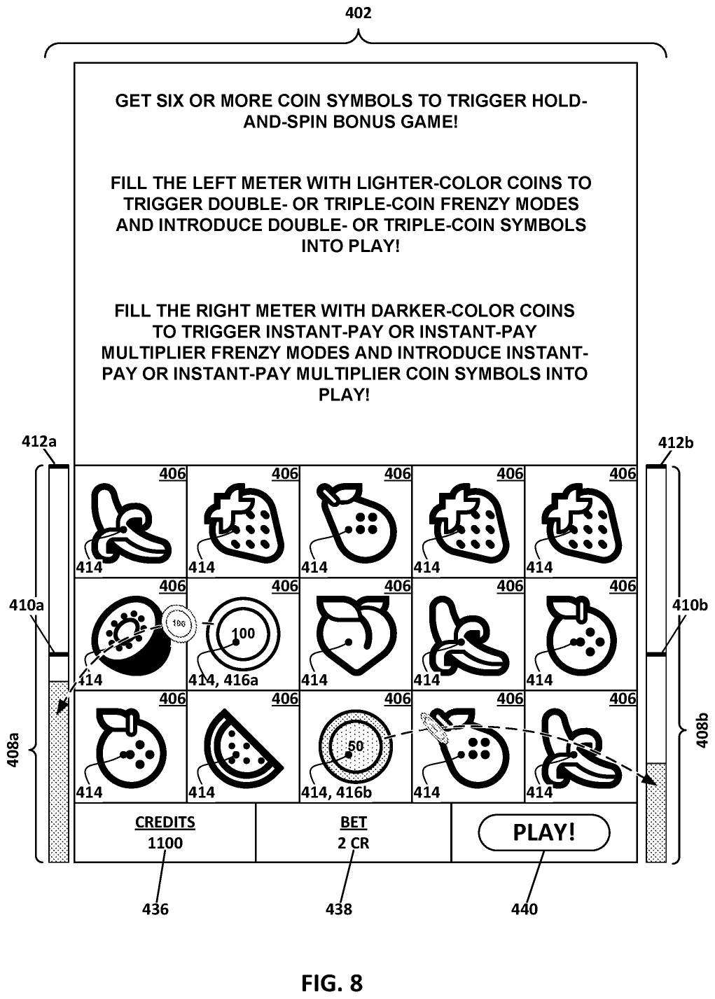

FIGS. 8 through 11 depict, for example, four frames of such an animation that may be played after the outcome of FIG. 7 is depicted. As can be seen, somewhat smaller versions/replicas of the trigger symbols 422 included in the feature symbol of the first type 416a and the feature symbol of the second type 416b are depicted as traveling along arced paths (represented by the dashed, arcing arrows, which may be shown, as depicted, or may not be shown/visible). The smaller versions/replicas of the trigger symbols 422 included in the feature symbol of the first type 416a and the feature symbol of the second type 416b are additionally shown as being in different rotational positions in each of the FIGS. 8 through 11, indicating that these trigger symbols 422 (or their replicas) are spinning end-over-end, e.g., as if they were coins being flipped from the feature symbol of the first type 416a and the feature symbol of the second type 416b into the first collection meter 408a or the second collection meter 408b, respectively. It will be understood that such animations may be presented in parallel for each feature symbol that is part of a base game outcome, as shown here, in series (one after the other), or in overlapping fashion, e.g., with the animation for each such feature symbol 416 starting before the end of another such animation.

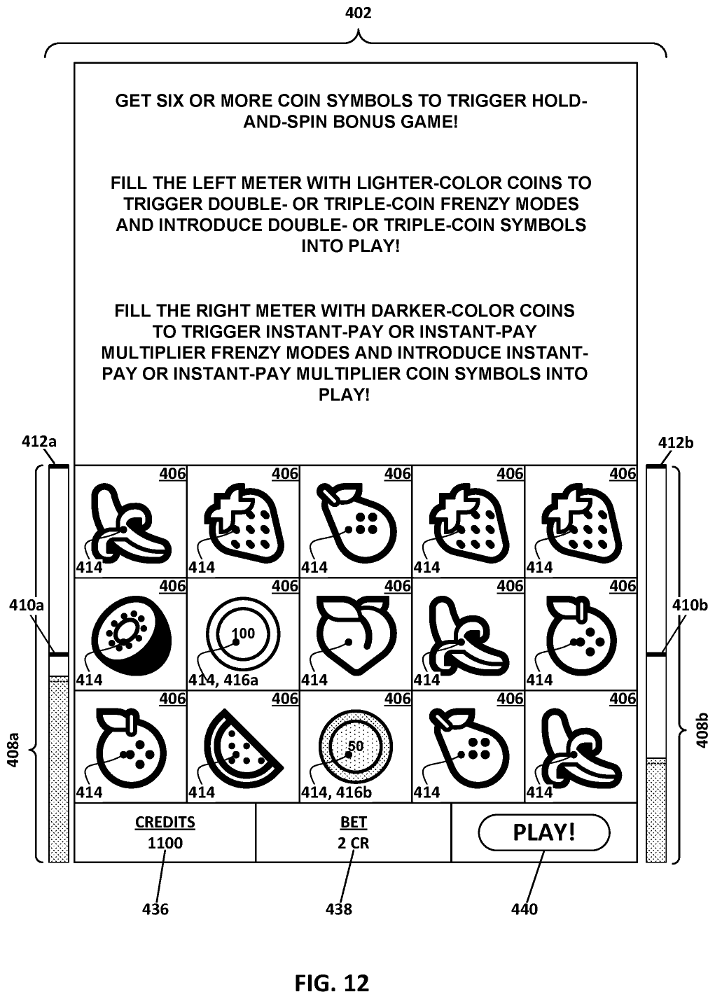

In conjunction with each animation depicted in FIGS. 8 through 11 concluding, the base game GUI 402 may be further caused to update the first collection meter 408a and/or the second collection meter 408b to reflect the additional trigger symbols 422 that were included in the feature symbols 416 that were displayed. FIG. 12 depicts the base game GUI 402 after the first collection meter 408a and the second collection meter 408b have both been updated to reflect the display of the additional trigger symbols 422 included in the feature symbol of the first type 416a and the feature symbol of the second type 416b, respectively. In this case, the shaded portions of the first collection meter 408a and the second collection meter 408b have been caused to expand upwards, e.g., by the portions between the dotted lines and the tops of the shaded portions.

While specifics of the animation that may be displayed in conjunction with display of a feature symbol 416 in a base game play have been explicitly depicted in FIGS. 8 through 12, future instances in which feature symbols 416 are displayed in a base game outcome may not be depicted in such detail and may instead be shown in simplified form, e.g., represented by a dashed line with an arrow at the end. However, it will be understood that similar such animations may be played for each such instance in which a feature symbol 416 is displayed in a base game outcome.

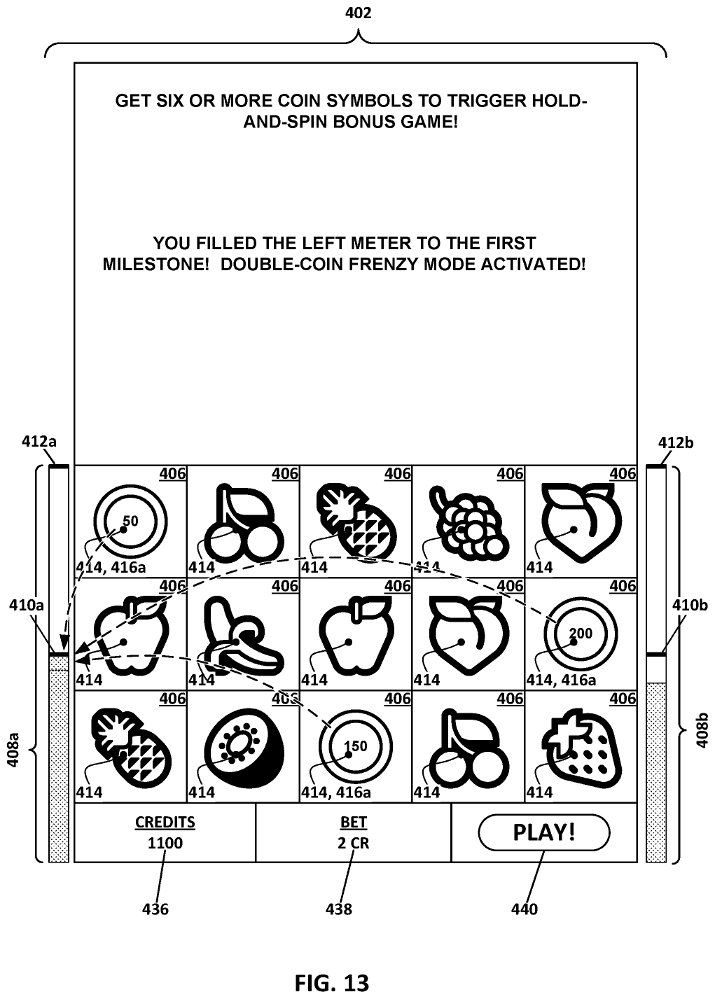

In FIG. 13, the base game GUI 402, has been updated to reflect a further base game play, with new symbols 414 being displayed in the symbol positions 406. In this base game play, three feature symbols of the first type 416a have been displayed in the top left, bottom middle, and middle right symbol positions 406. Accordingly, the first collection meter 408a has been caused to be updated to reflect the additional three trigger symbols 422 that are included in those feature symbols of the first type 416a. As can be seen, the shaded portion of the first collection meter 408a has expanded upwards and now meets the first feature first collection goal 410a. The area above the array of symbol positions 406 has been updated to depict informative text indicating that the first feature first collection goal 410a has been met (“the first milestone” of the “left meter”), and that this has caused “double-coin frenzy mode” to be activated.

As discussed earlier, the feature symbols 416 may be progressed through various levels of upgrade or enhancement as the first feature and second feature first and second collection goals are met. In this case, when the first feature first collection goal 410a is met, the feature symbol 416 enhancement that is unlocked is that the feature symbols of the first type 416a that may be selected and displayed as part of a base game outcome (or in a bonus game outcome) may be either feature symbols of the first type 416a that are unenhanced, e.g., as they were prior to the first feature first collection goal 410a being met, or feature symbols of the first type 416a that have been enhanced to a first level of enhancement. In this instance, the feature symbols of the first type 416a that have been enhanced to a first level of enhancement each have two trigger symbols 422 instead of only a single trigger symbol 422.

Moreover, whenever a first feature or second feature first or second collection goal is met, a frenzy mode may be activated for the base game in which every instance of the feature symbol 416 of the same type as the feature symbol(s) 416 that, in being displayed, caused the first feature or second feature first or second collection goal to be met is caused to be the enhanced or upgraded version of that feature symbol that is then unlocked in response to the first feature or second feature first or second collection goal being met. A frenzy mode is, for the purposes of this disclosure, a mode in which the base game may, for a fixed- or limited-duration, cause all instances of a feature symbol 416 of a particular type that are displayed in base game outcomes for base game plays initiated while the frenzy mode is active or in effect to be at the highest level of enhancement for such a feature symbol 416 that is presently “unlocked” due to the player meeting a first feature or second feature first or second collection goal. Normally, once a player has met a first feature or second feature first or second collection goal, the enhanced state of the corresponding feature symbol 416 that is unlocked or made available during play as a result of meeting such a collection goal is made potentially obtainable in base game outcomes occurring after such unlocking, but in parallel with the non-enhanced versions of that feature symbol 416. Thus, for example, once a first enhanced version of the feature symbol of the first type 416a has been Unlocked, a Given Base Game Play During Non-frenzy mode base game play may produce a base game outcome that has no feature symbols of the first type 416a, one or more unenhanced feature symbols of the first type 416a and no first enhanced versions of the feature symbols of the first type 416a, one or more first enhanced versions of the feature symbols of the first type 416a and no unenhanced feature symbols of the first type 416a, or a combination of unenhanced and first enhanced versions of the symbols of the first type 416a. In contrast, such a base game play that occurs while the frenzy mode is active may include one or more first enhanced versions of the feature symbol of the first type 416a but will not include any non-enhanced versions of the feature symbol of the first type 416a.

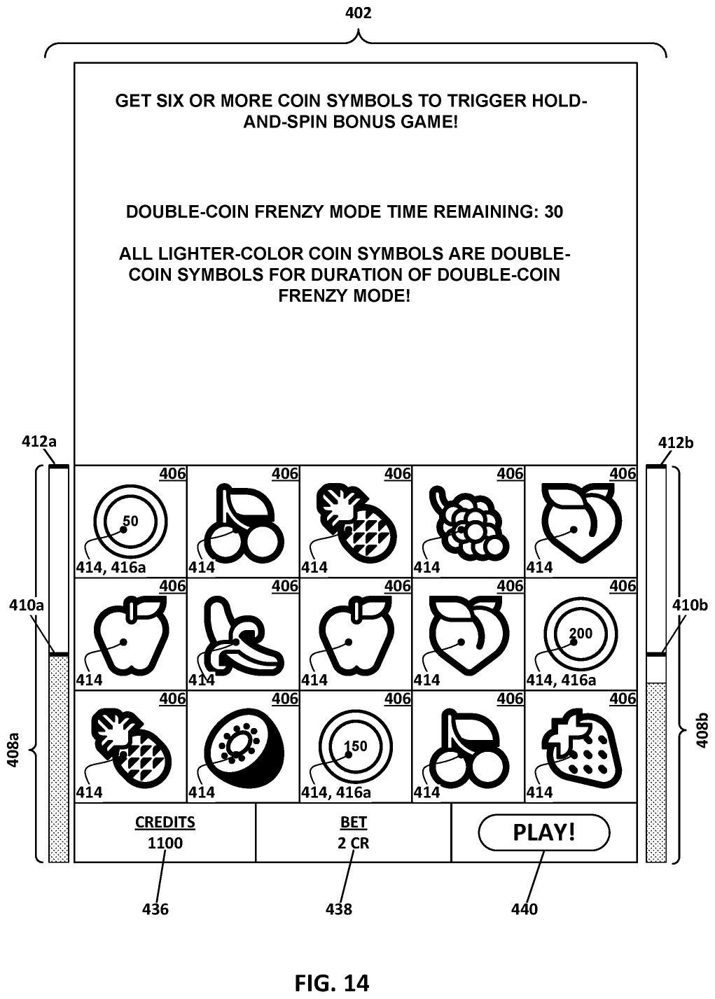

As shown in FIG. 14, the textual information provided by the base game GUI 402 has been updated to indicate that a double-coin frenzy mode is active and that the amount of time, e.g., 30 seconds, that remains before the frenzy mode concludes. The information also indicates that all of the lighter-color coin symbols (the feature symbols of the first type 416a) are double-coin symbols (the first enhanced version of the feature symbols of the first type 416a) for the duration of the frenzy mode.

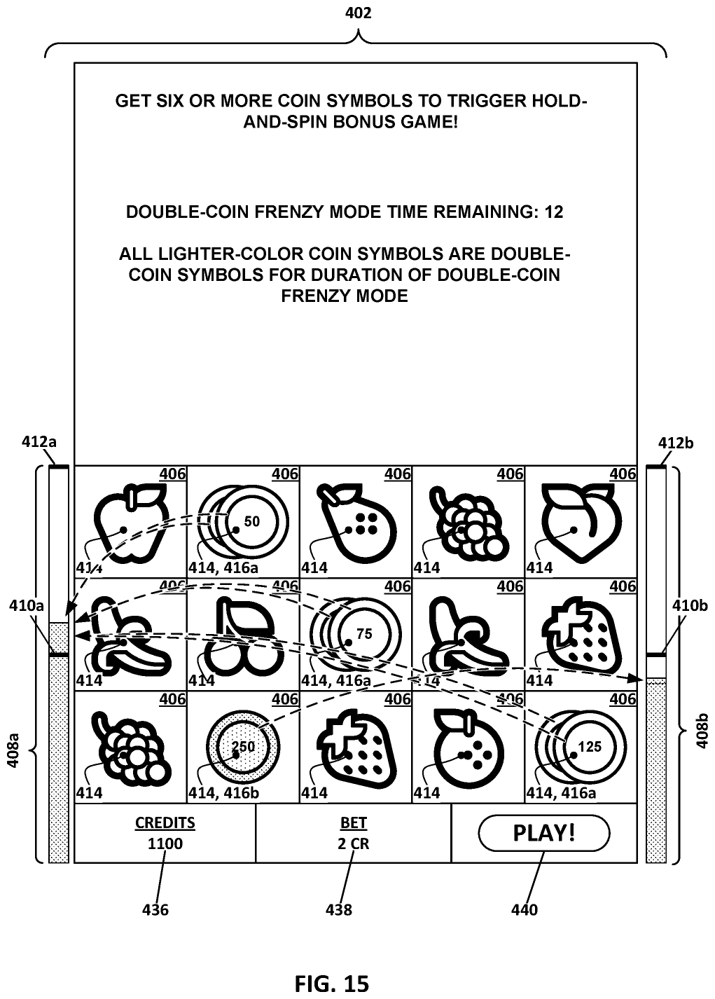

FIG. 15 depicts a base game outcome that occurred while the frenzy mode indicated in FIG. 14 was still active, e.g., with 12 seconds left. As can be seen, the base game outcome has resulted in three feature symbols of the first type 416a being displayed, each being the first enhanced version of the feature symbol of the first type 416a and including two trigger symbols 422 (coins). The base game outcome also includes a feature symbol of the second type 416b which is in an unenhanced state and displays a single trigger symbol 422. The base game GUI 402 has been updated to reflect the trigger symbols 422 displayed in the base game outcome of FIG. 15, e.g., by expanding the shaded portion of the first collection meter 408a by an amount commensurate with the six trigger symbols 422 included in the three feature symbols of the first type 416a that are displayed and by expanding the shaded portion of the second collection meter 408b by an amount commensurate with the single trigger symbol 422 included in the single feature symbol of the second type 416b that is displayed.

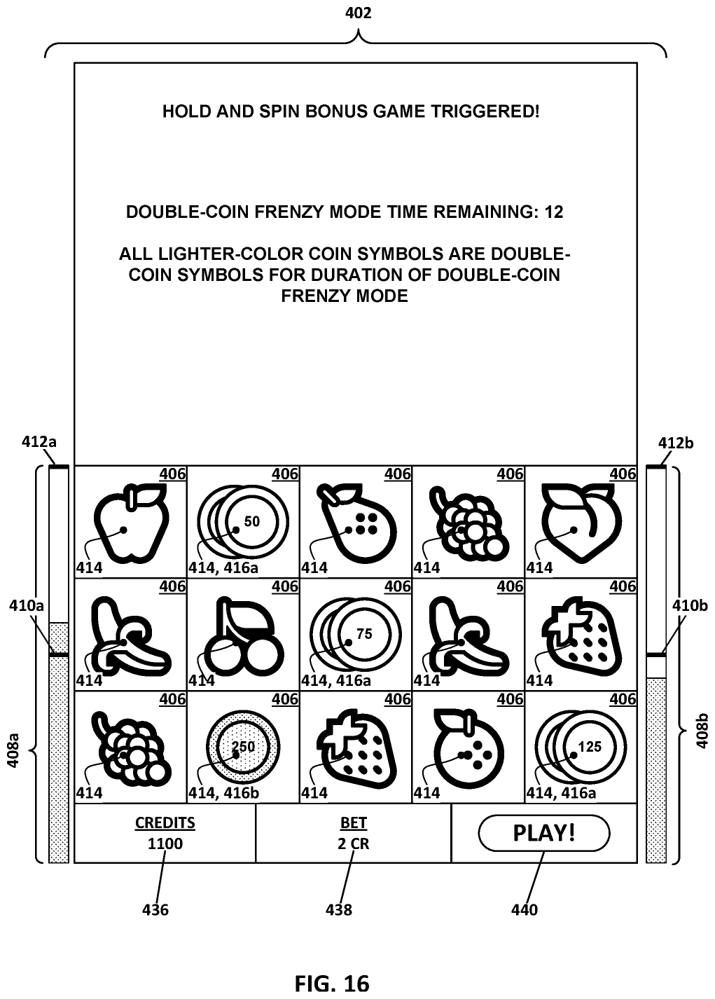

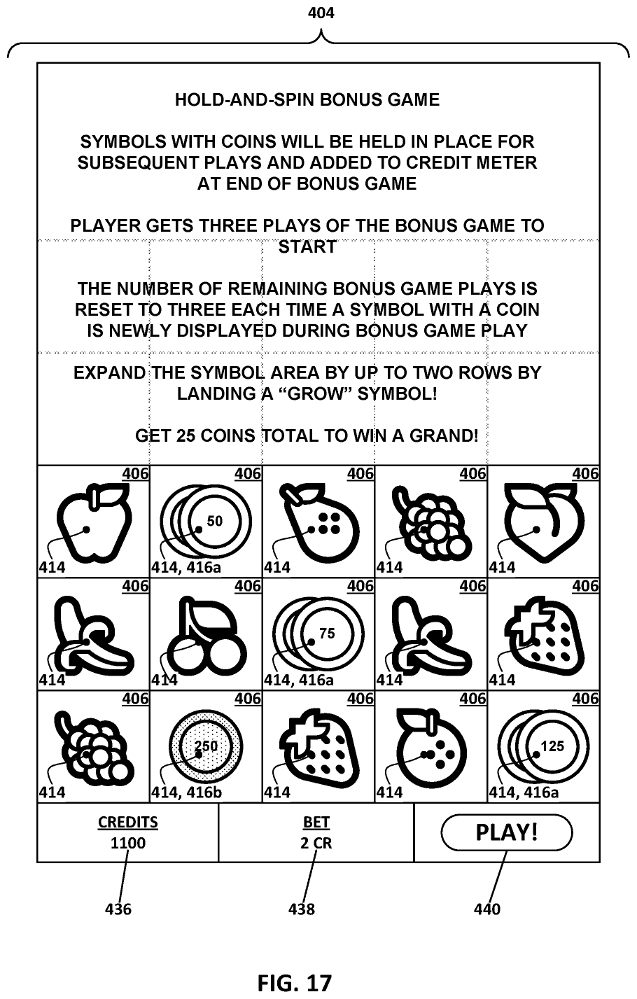

The seven trigger symbols 422 that are displayed in the base game outcome of FIG. 15 exceed the minimum number of trigger symbols required to trigger the bonus game. The base game GUI, as shown in FIG. 16, may be updated to indicate that the bonus game, e.g., a hold-and-spin bonus game, has been triggered and that the frenzy mode will resume once the bonus game is finished. The base game GUI 402 may then be caused to transition to a bonus game GUI 404. As can be seen, the bonus game GUI 404 may indicate, for example, that the bonus game is a hold-and-spin bonus game in which the player is initially provided with a predetermined number of bonus game plays, e.g., three bonus game plays, and that any coin symbols (feature symbols 416) that are newly displayed in a symbol position 406 as a result of a bonus game play will a) cause the number of bonus game plays to be reset to the initial number of bonus game plays (or, in other implementations, set to some other number, e.g. incremented by one or by two, or to some other fixed number different from the initial number of bonus game plays) and b) be held in place for future bonus game plays during the current bonus game instance. The information also indicates that the bonus game in question has a “growth” feature that may be activated when a bonus game outcome includes a “grow” symbol (e.g., the expansion symbol 420). In this case, the bonus game GUI 404 is configured to permit the number of symbol positions 406 to be expanded by up to two rows during bonus game play, thereby increasing the number of symbol positions 406 in which symbols 414 may be displayed to a total of twenty-five symbol positions in this example. Of course, other implementations may feature similar expansion features that expand the number of symbol positions 406 by other amounts, e.g., a single row of symbol positions 406, a single column of symbol positions 406, multiple columns of symbol positions 406, etc. In FIG. 17, dotted/dashed lines above the symbol positions 406 indicate potential additional symbol positions 406 that may be added in response to an expansion symbol 420 being displayed in a bonus game outcome.

The information may also indicate that a grand award may be provided, e.g., added to the score or credit meter 436, responsive to the display of a certain number of trigger symbols 422 (coin symbols) in the bonus game GUI 404.

The bonus game GUI 404 may include the array of symbol positions 406 that are used in the base game GUI 402 and may include the symbols 414, including the feature symbols 416, that were displayed in the base game GUI 402 that caused the bonus game to be triggered. In some implementations, the feature symbols 416 that are used in the bonus game GUI 404 may have exactly the same visual appearance as those same feature symbols 416 have in the base game GUI 402, as shown here, but it will be appreciated that other implementations may utilize analogous, but graphically distinguishable versions of the feature symbols 416 (or the symbols 414 more generally) in the bonus game GUI 404 as compared with the base game GUI 402. For example, the feature symbols 416 may, in the base game GUI 402, be represented by symbols of two different colors (one for each feature symbol type) but may be represented in the bonus game GUI 404 by the same symbols in two other different colors. In such a case, the graphical appearance of such symbols may be updated to the appearance of the analogous symbol in the bonus game GUI 404 when the base game GUI 402 is transitioned to the bonus game GUI 404. Such a convention may help communicate to the player more clearly that the game is currently presenting a bonus game instead of a base game.

The bonus game GUI 404 may also, in some implementations, be caused to omit the first collection meter 408a and the second collection meter 408b. As feature symbols 416 that are displayed as part of a bonus game outcome are not the result of base game plays that may serve to contribute towards completing a first or second feature first or second goal, there will be no bonus game outcomes that contribute towards completing a first or second feature first or second goal. Accordingly, display of the first collection meter 408a or the second collection meter 408b may be unnecessary and may even confuse a player if they are displayed. To that end, the bonus game GUI 404 omits such meters. However, other implementations may retain the first collection meter 408a and the second collection meter 408b but alter them in some fashion to communicate that they are not “active” during the bonus game play. For example, the first collection meter 408a and the second collection meter 408b may be caused to be presented in faded-out and/or greyscale graphics relative to the remainder of the bonus game GUI 404 to communicate that the first collection meter 408a and the second collection meter 408b are in an inactive state.

In this example, the bonus game ends when a predetermined number of symbol positions 406 that are displayed in the bonus game GUI 404 have feature symbols 416 displayed therein or when the number of available bonus game plays reaches zero for a bonus game play that results in no feature symbol 416 being newly displayed in a symbol position 406.

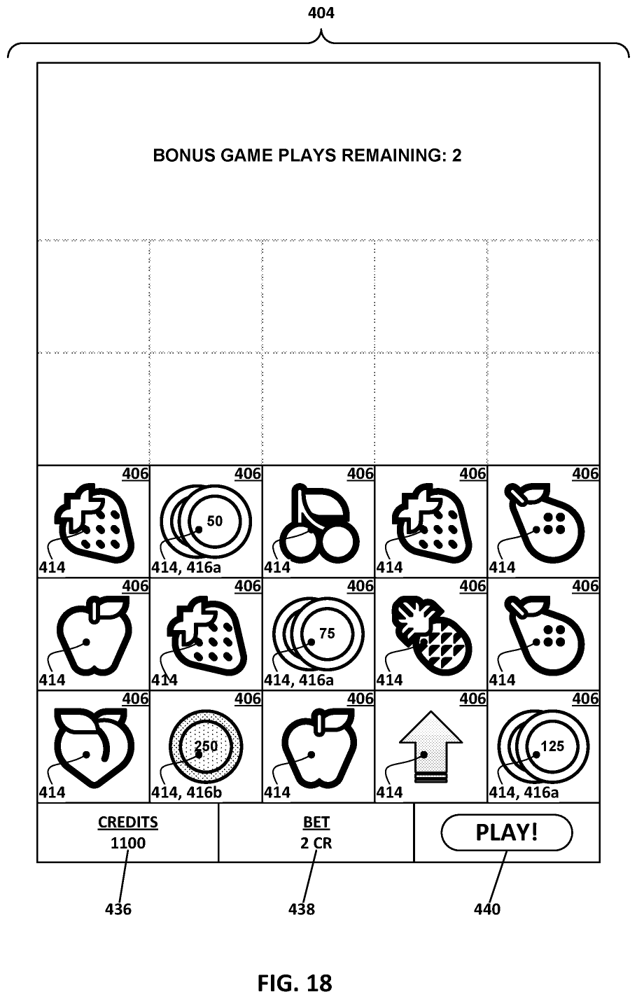

FIG. 18 depicts the bonus game GUI 404 after a bonus game play has occurred that resulted in new symbols 414 being selected and displayed in the symbol positions 406 that did not depict feature symbols 416 immediately prior to that bonus game play. The symbols selected for display in the bonus game may also be randomly selected, e.g., similar to how the symbols for base game outcomes are randomly selected.

Thus, the bonus symbols 416 that were displayed in the symbol positions 406 in the second column from the left in the top row, the middle column of the middle row, and the second from the left and rightmost columns of the bottom row are retained, but new symbols 414 have been selected and displayed in all of the remaining symbol positions 406. In this particular example, an expansion symbol 420 has been selected and displayed in the symbol position 406 in the second column from the right of the bottom row.

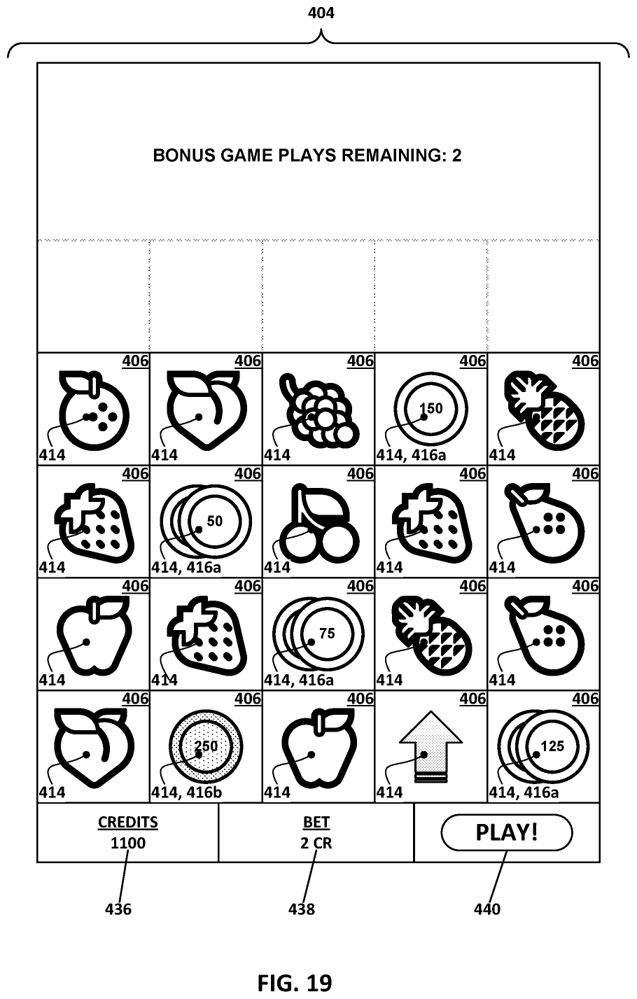

As shown in FIG. 19, this causes the bonus game GUI 404 to add a fourth row of symbol positions 406 to the array of symbol positions 406, along with symbols 414 that have been selected for display in the newly displayed symbol positions 406. As can be seen, the newly displayed symbol 414 in the newly displayed symbol position 406 in the second from the right column of symbol positions 406 in the fourth row of symbol positions 406 happens to be an additional feature symbol of the first type 416a.

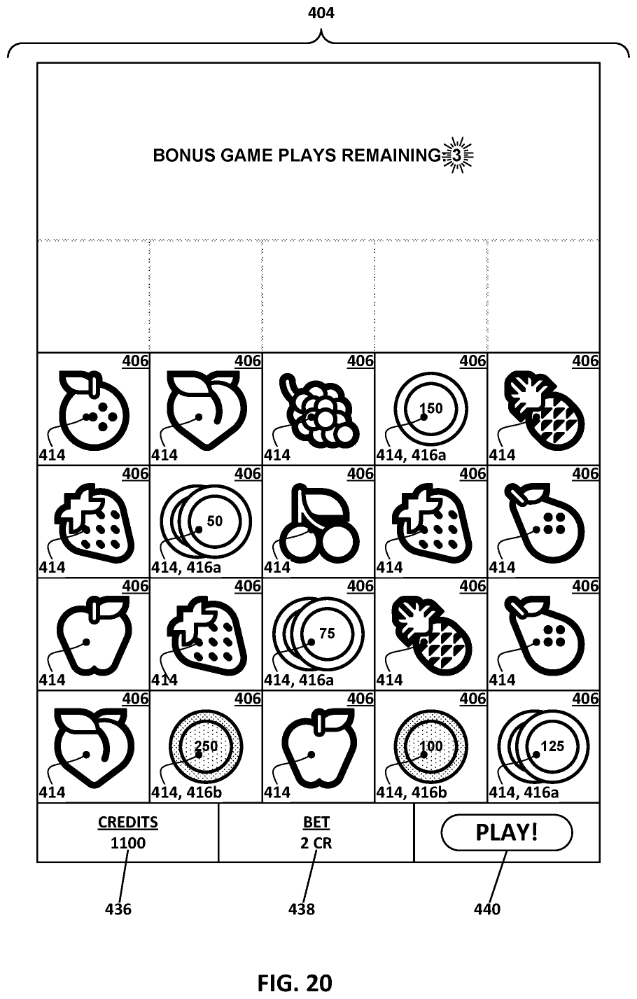

The expansion symbol 420 may then be caused to be replaced by a feature symbol 416, as shown in FIG. 20. In this particular example, a feature symbol of the second type 416b has been selected to replace the expansion symbol 420 in the symbol position 406 in the second-from-the-right column of the bottom row. The bonus game GUI 404 has also been caused to update the number of bonus game plays remaining, e.g., back to the number of bonus game plays that were provided at the start of the bonus game.

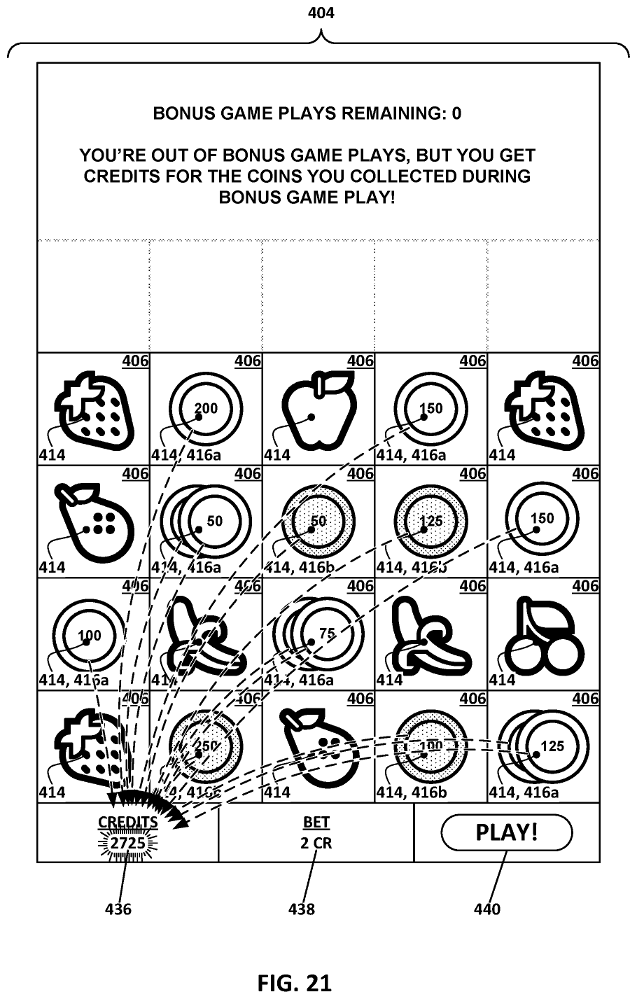

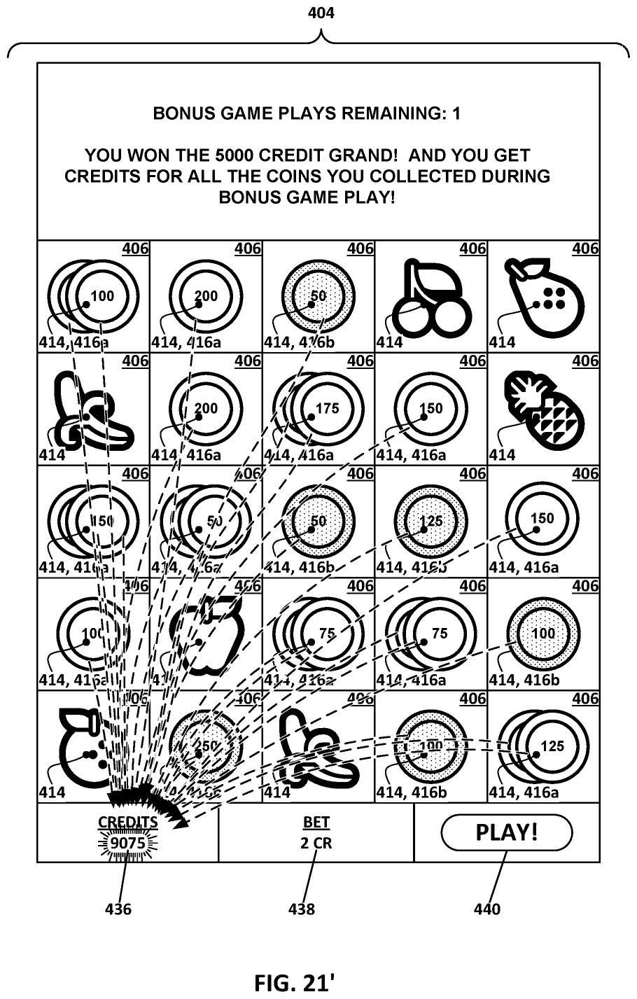

As discussed above, play of the bonus game may continue until one or more end conditions are met. For example, in FIG. 21, a bonus game play has just completed in which no new feature symbols 416 have been displayed (the feature symbols 416 that are depicted in the bonus game GUI 404 of FIG. 21 will be understood to have been first displayed in previous bonus game plays that occurred prior to the most recent bonus game play, or which were displayed due to being in the base game outcome that triggered the bonus game in the first place). This particular bonus game play has also resulted in the number of remaining bonus game plays being decremented to zero. As no bonus game plays are remaining and none of the symbols newly displayed in the symbol positions as a result of the current bonus game play are feature symbols, the bonus game has reached an end point and concludes.

When the bonus game concludes, the score or credit meter may be incremented by the amounts indicated by the value indications 428 for each feature symbol 416 that is displayed. In this case, the feature symbols 416 are to be understood to have value indications that show the value associated with each trigger symbol displayed, i.e., for the feature symbols of the first type 416a, the value indicated by the value indications 428 is twice the numeric value indicated on that feature symbol of the first type 416a, while for the remaining feature symbols 416, the value indicated by the value indications 428 is simply the numeric value indicated on that feature symbol 416. Thus, at the conclusion of the bonus game, the bonus game GUI 404 may be caused to add the values indicated by the value indications 428 to the score or credit meter 436. In this case, the values indicated by the value indications 428 for all of the displayed feature symbols 416 add up to a total of 1625 points or credits.

FIG. 21′ depicts the bonus game GUI 404 in which the bonus game has just completed because the bonus game outcome includes feature symbols 416 that include a total number of trigger symbols 422 that meet or exceed a predetermined threshold, e.g., 25 trigger symbols 422 in this case. Reaching the threshold, in this case, not only causes the bonus game to conclude but also causes a grand jackpot award to be added to the score or credit meter 436.

In some instances, such as the present implementation, the predetermined number of trigger symbols 422 may be set to equal the maximum number of symbol positions 406 that can be included in the bonus game GUI 404, e.g., after the array of symbol positions 406 has been expanded to its maximum possible size through display of expansion symbol(s) 420. Setting the predetermined number to such a value makes it possible to achieve a bonus game outcome in which the predetermined number of trigger symbols 422 is displayed regardless of whether not the “enhanced” version of the feature symbols of the first type 416a have been unlocked. For example, if none of the first or second feature first or second collection goals has been met, then the predetermined number of trigger symbols 422 can still be displayed if a bonus game outcome is achieved in which the array of symbol positions 406 is at its maximum expanded size and every symbol position 406 therein contains a feature symbol 416. However, as first feature first and second collection goals are met, it will become easier and easier to achieve a bonus game outcome that includes the predetermined number of trigger symbols 422. For example, it is possible to achieve a bonus game outcome in which a number of “enhanced” versions of the feature symbols of the first type 416a are displayed—the additional trigger symbols 422 included in such enhanced feature symbols of the first type 416a may contribute towards meeting the threshold of 25 trigger symbols 422 without requiring that another feature symbol 416 be displayed in the symbol positions 406. In an extreme case, it would be possible for a bonus game outcome to present the threshold number of trigger symbols 422, e.g., 25 trigger symbols 425, without any expansion of the array of symbol positions 406, for example, if “enhanced” feature symbols of the first type 416a were to be displayed in two-thirds of the symbol positions 406 and non-enhanced feature symbols 416 were displayed in the remaining symbol positions 406.

In FIG. 21′, it can be seen that there are a total of 25 trigger symbols 422 included in the eighteen feature symbols 416 that are displayed in the bonus game outcome depicted. Animations may be displayed showing representations of the trigger symbols 422 from each feature symbol 416 cascading down into the score or credit meter 436, e.g., similar to the animations used to indicate when trigger symbols 422 displayed in a base game outcome contribute towards incrementing the first collection meter 408a or the second collection meter 408b. The score or credit meter 436, in this example, has been incremented by 7975 credits-5000 credits for the grand award and 2975 credits for the values indicated by the value indications 428 of the feature symbols 416.

It will also be understood that in some implementations, the bonus game may conclude when the number of bonus game plays reaches zero as the result of a bonus game play in which no feature symbols 416 are newly displayed in any of the symbol positions 406 in the bonus game GUI 404 or when all of the symbol positions 406 that are displayed in the bonus game GUI 404 have feature symbols 416 displayed therein. In such implementations, there may still be a threshold number of trigger symbols 422 that governs when a large award, e.g., a grand award, is awarded. However, the award of that grand award may not necessarily cause the bonus game to conclude. For example, in the example of FIG. 21′, there are still seven symbol positions 406 that do not display feature symbols 416. If such a bonus game play outcome were to happen in such an alternative implementation, the grand award would still be provided, but the number of bonus game plays would then be reset (since a feature symbol 416 would have been newly displayed in the bonus game play that most recently occurred) and the player would have at least three more bonus game plays in which additional feature symbols 416 could potentially be displayed in the remaining seven symbol positions 406 (and if such a feature symbol 416 were to be newly displayed during such a further bonus game play, it would cause the number of bonus game plays remaining to be reset again, providing even further opportunities for bonus game outcomes to occur that might result in additional feature symbols 416 being newly displayed).

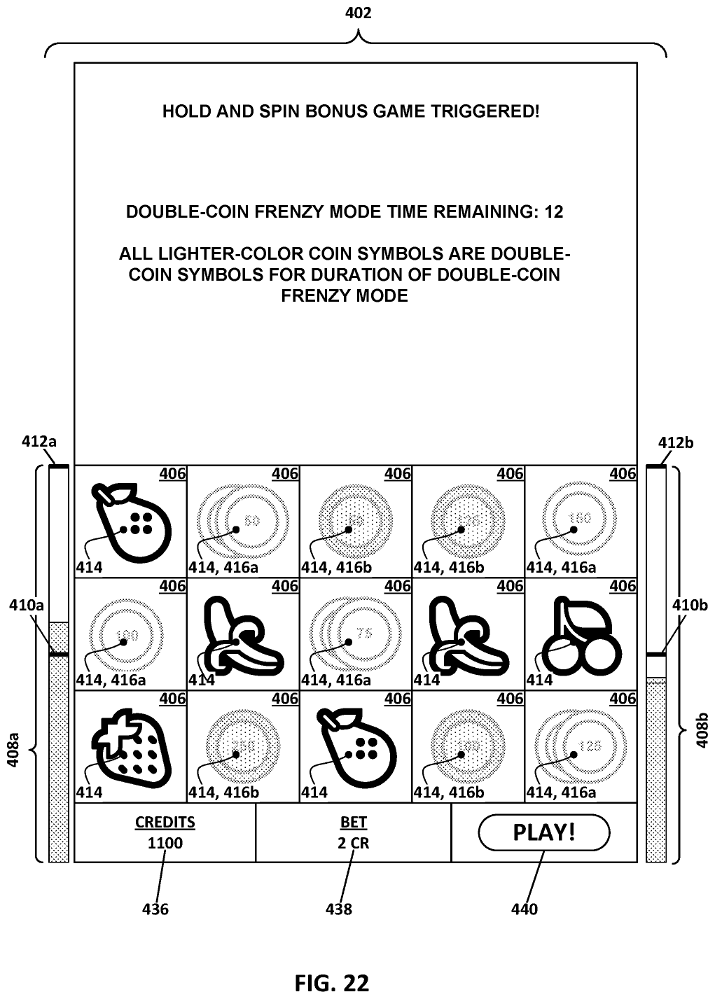

Regardless of how the bonus game concludes, once the bonus game has concluded and the score or credit meter 436 has been updated to reflect the values indicated by the value indications 428 of the feature symbols 416 displayed in the bonus game GUI 404, as well as any other awards, e.g., a grand award, that may have been awarded in the bonus game, the bonus game GUI 404 may then be caused to transition back to the base game GUI 402. For example, the array of symbol positions 406, if in an expanded state, may be caused to revert back to its base game state, and the first collection meter 408a and the second collection meter 408b may both be caused to be displayed again, reflecting the progress made towards the first and second feature first and second collection goals prior to the initiation of the bonus game that just concluded. As the feature symbols 416 that are displayed during bonus game play do not contribute towards meeting the first and second feature first and second collection goals, the feature symbols 416 that were displayed at the conclusion of the bonus game may, for example, be depicted as greyed out (as shown in FIG. 22, which shows the base game GUI 402 after transitioning from the bonus game GUI shown in FIG. 21) to communicate to the player that the trigger symbols 422 for such feature symbols will not be counted towards meeting the first or second feature first or second collection goals. In other implementations, such feature symbols 416 may simply be caused to disappear when transitioning to the base game GUI 402.

As can be seen, the textual information that is displayed in the top half of the base game GUI 402 indicates that the double-coin frenzy mode still has 12 seconds remaining (the amount remaining when the bonus game that just concluded was initiated). Thus, the predetermined period of time that the frenzy mode is active for is cumulative of the time actually spent in base game play while the frenzy mode is active but does not include time spent in bonus game play after the frenzy mode is initiated and prior to the conclusion of the frenzy mode. Put another way, the frenzy mode may be “paused” or “suspended” while bonus game play is occurring (and during the transition from the base game GUI 402 to the bonus game GUI 404 or vice-versa) and may then resume once base game play resumes after conclusion of the bonus game. It will be understood that multiple instances of the bonus game may, in some cases, be triggered while a frenzy mode is active, and that there may accordingly be multiple pauses or suspensions of the frenzy mode while such bonus game instances are resolved.

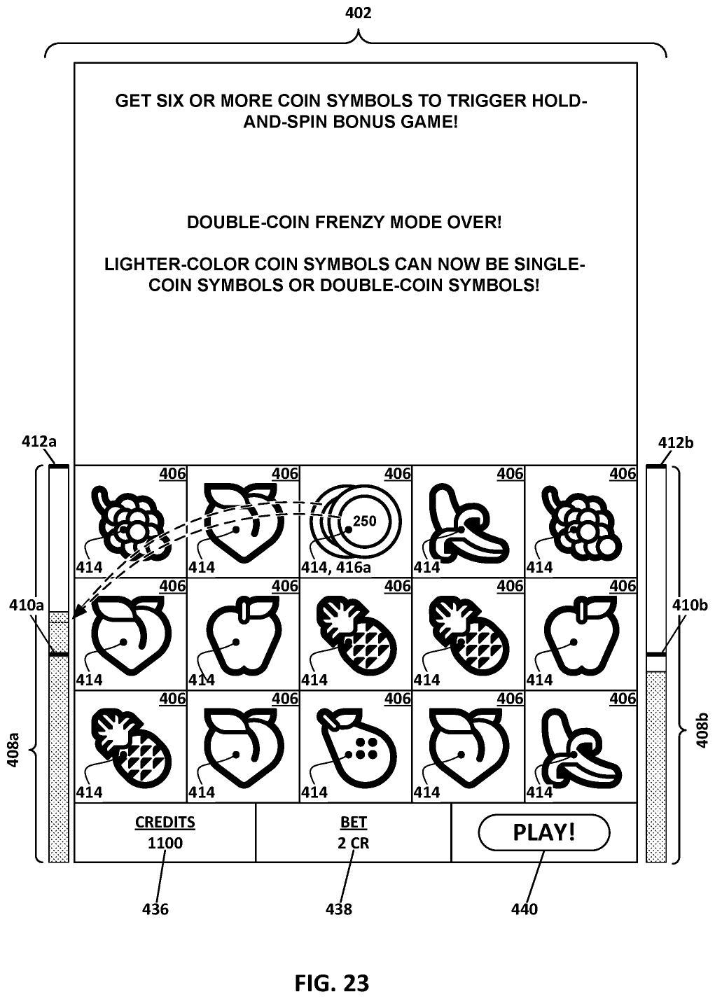

In FIG. 23, the base game GUI 402 has been updated to indicate that the double-coin frenzy mode has concluded. Additionally, the first collection meter 408a has been updated to reflect additional progress towards the first feature second collection goal 412a due to the display of two additional trigger symbols 422 included in the feature symbol 416 displayed in the middle symbol position 406 of the top row of symbol positions 406.

It will be understood that, in similar fashion, when the first feature second collection goal 412a is met, then the enhanced version of the feature symbol of the first type 416a that was available for selection and display in base game and bonus game outcomes, in addition to the unenhanced versions of the feature symbol of the first type 416a, after the first feature first collection goal 410a was met may be replaced with a further enhanced version of the feature symbol of the first type 416a. For example, the enhanced version of the feature symbol of the first type 416a that may be displayed in base game or bonus game outcomes may have three trigger symbols 422 instead of two trigger symbols 422 once the first feature second collection goal 412a is met. Additionally, a frenzy mode may be initiated responsive to the first feature second collection goal 412a being met in which every feature symbol of the first type 416a that is available for display is an enhanced version of the feature symbol of the first type 416a, e.g., with three trigger symbols 422.

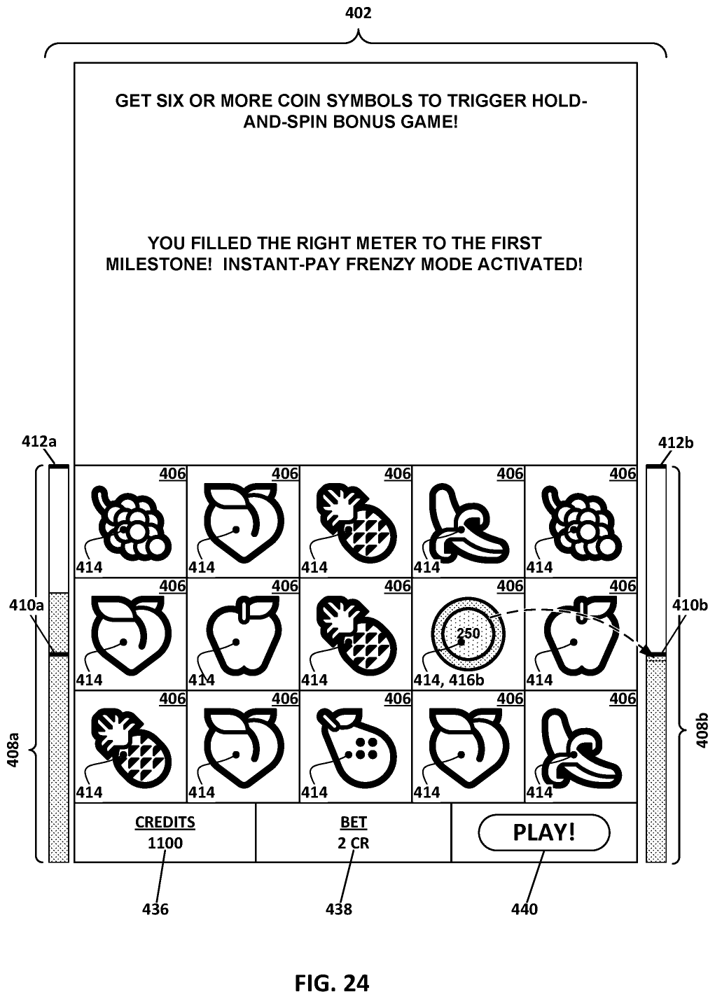

In implementations with a second collection meter 408b, as shown in FIG. 24, enhanced versions of the feature symbols of the second type 416b may similarly be unlocked when the second feature first or second collection goals 410b or 412b are met. For example, the when the second feature first collection goal 410b is met, enhanced versions of the feature symbol of the second type 416b may be included—in addition to the unenhanced versions of the feature symbol of the second type 416b—in the symbols 414 from which symbols 414 are selected for display in the symbol positions 406 for base game and bonus game outcomes. As discussed previously, such enhanced versions of the feature symbols of the second type 416b may, for example, be associated with an instant award status that causes the base game GUI 402 (or the bonus game GUI 404, depending on in which GUI the enhanced version of the feature symbol of the second type 416b is displayed) to add the value indicated by the value indication 428 for such an enhanced version of the feature symbol of the second type 416b to the score or credit meter 436 responsive to the display of that enhanced version of the feature symbol of the second type 416b, e.g., immediately or nearly immediately after the display of that feature symbol of the second type 416b. Thus, for example, when such an enhanced version of the feature symbol of the second type 416b is displayed in the bonus game GUI 404, the score or credit meter 434 will eventually have the value indicated by the value indication 428 of that feature symbol of the second type 416b added to the amount in the score or credit meter 434 at least twice-once when the enhanced version of the feature symbol of the second type 416b is first displayed, and then again when the bonus game concludes and the values indicted by the value indications 428 of all of the feature symbols 416 displayed in the final bonus game outcome are added to the score or credit meter 434. If an enhanced version of the feature symbol of the second type 416b is displayed during base game play without triggering the bonus game, then the value indicated by the value indication 428 of that feature symbol of the second type 416b may be added to the score or credit meter 434, but only at the time the feature symbol of the second type 416b is displayed (and not again at a later time).

When the second feature second collection goal 412b is met, the enhanced versions of the feature symbols of the second type 416b may be replaced with additionally enhanced versions of those feature symbols of the second type 416b. For example, as discussed earlier, the additionally enhanced versions of the feature symbols of the second type 416b may be similar to the initially enhanced versions of the feature symbols of the second type 416b but may also be associated with a multiplier value that causes the amount indicated by the value indications 428 thereof to be multiplied by the multiplier prior to being added to the score or credit meter 434. In this respect, such enhanced versions of the feature symbols of the second type 416b may act somewhat like enhanced versions of the feature symbols of the first type 416a in which there are two trigger symbols 422 in terms of the amount added to the score or credit meter 434, but may act like an unenhanced version of the feature symbols of the first type 416a with respect to triggering the bonus game and/or having the threshold number of trigger symbols 422 displayed in a bonus game outcome.

Additionally, whenever the second feature first collection goal 410b or the second feature second collection goal 412b is met, a corresponding frenzy mode may be triggered in which the most recently unlocked “enhanced versions” of the feature symbols of the second type 416b are the only versions of the feature symbols of the second type 416b selectable for display in base game outcomes.

In some implementations, once the first and second feature first and second collection goals have all been met (and the associated frenzy modes—and any bonus game instances triggered during such frenzy modes-completed), the base game GUI 402 may be caused to reset the first collection meter 408a and the second collection meter 408b. In some instances, the base game GUI 402 may, as part of resetting the first collection meter 408a and the second collection meter 408b (or when a player first starts to play the base game, e.g., after first selecting the base game for play on a gaming machine), present a base game meter initialization GUI in which, for example, multiple selectable options are presented. Each such option may correspond with a different combination of initialization states for the first collection meter 408a and the second collection meter 408b. For example, in some implementations, there may be two such states-one that causes the first collection meter to be initialized with the progress towards the first feature first collection goal 410a set to an initial, non-zero progress level, e.g., 33% of the way to the first feature first collection goal 410a, and another that causes the second collection meter 408b to be initialized with the progress towards the second feature first collection goal 410b set to an initial, non-zero progress level, e.g., 25% of the way to the second feature first collection goal 410b. In some further examples, there may be an additional selectable option that causes both the first collection meter 410a and the second collection meter 410b to be initialized with the progress towards the first feature first collection goal 410a and the second feature first collection goal 410b, respectively, to be set to initial, non-zero progress levels, e.g., 33% and 25% of the way towards the first feature first collection goal 410a and the second feature first collection goal 410b, respectively. It will be understood that the selectable options in such a base game meter initialization GUI may be presented in such a GUI such that there is no indication of which benefit arises from each selectable option, i.e., such that the benefit that is obtained through such selection is randomly selected.

It will be generally recognized that a controller, e.g., including one or more processors and one or more memory devices storing computer-executable instructions for controlling the one or more processors, may be configured via such computer-executable instructions to cause GUIs such as the above-discussed base game GUI 402 and bonus game GUI 404 to be presented and to update the GUIs as discussed above.

Such a controller may, for example, be configured with computer-executable instructions which, when executed, cause the one or more processors to cause a base game GUI to be displayed on one or more displays of a gaming machine, the base game GUI including an array of symbol positions and a first collection meter indicating progress towards meeting a first feature first collection goal. Such instructions may also be configured to cause the one or more processors to cause a first feature first mode to be activated responsive to initialization of the first collection meter and then deactivated responsive to the first feature first collection goal being met—the first feature first mode is, it will be understood, when the feature symbols of the first type are all in an unenhanced state. For example, each feature symbol of the first type may be caused to include only a first amount of corresponding trigger symbols while the first feature first mode is active.

Such instructions may be further configured to cause the one or more processors cause a first feature first frenzy mode to be activated responsive to the first feature first collection goal being met and then deactivated after being active for a first feature first predetermined cumulative time period, e.g., 30 seconds or 60 seconds. The first feature first predetermined cumulative time period, it will be understood, may be the total of multiple time periods during which base game play occurs, but which are interspersed with one or more periods of time in which instances of the bonus game may occur. Each feature symbol of the first type may, for example, be caused to include only a second amount (larger than the first amount) of corresponding trigger symbols while the first feature first frenzy mode is active.

The instructions may also be further configured to cause the one or more processors cause a first feature second mode to be activated responsive to deactivation of the first feature first frenzy mode, e.g., after the first feature first frenzy mode has concluded. The first feature second mode is, it will be understood, when the feature symbols of the first type 416a that are displayed in base game or bonus game outcomes may be either unenhanced feature symbols of the first type 416a or enhanced versions of the feature symbols of the first type 416a. Put another way, each feature symbol of the first type may include either the first amount of corresponding trigger symbols or the second amount of corresponding trigger symbols while the first feature second mode is active. In some instances, the first amount may be one and the second amount may be two, but other implementations may use different amounts for the first amount and the second amount.

In some implementations, the base game GUI may include only the first collection meter (and no additional collection meters) and there may be only the three modes discussed above. However, in other implementations, there may be additional modes and//or collection meters.

The instructions may also include instructions for causing the one or more processors to determine that the first feature first collection goal is met when a first cumulative number of the trigger symbols has been displayed in the feature symbols of the first type in base game plays using the base game GUI and since the first collection meter was last initialized. The instructions may also cause the one or more processors to cause the base game GUI to display, while the first feature frenzy mode is active, a first feature first frenzy mode timer configured to indicate how long until the first frenzy mode deactivates.

In some implementations, there may be one or more additional first feature first collection goals, e.g., a first feature second collection goal. In such implementations, the instructions may be further configured to cause the first collection meter to also indicate progress towards meeting the first feature second collection goal. The instructions may also be configured to cause the first feature second mode to be deactivated, and then cause a first feature second frenzy mode to be, activated responsive to the first feature second collection goal being met and then deactivated after being active for a first feature second predetermined cumulative time period, e.g., 30 or 60 seconds. The first feature second predetermined cumulative time period, it will be understood, may be similar to the first feature first predetermined cumulative time period, e.g., including time intervals in which base game plays occur, but excluding time periods spent in bonus game play. Each feature symbol of the first type may, for example, be caused to include only a third amount (larger than the second amount) of corresponding trigger symbols while the first feature second frenzy mode is active. In some instances, the first amount may be one, the second amount may be two, and the third amount may be three, but other implementations may use different amounts for the first amount, the second amount, and the third amount.

In such implementations, the instructions may further cause the one or more processors to cause a first feature third mode to be activated responsive to deactivation of the first feature second frenzy mode. The first feature third mode, it will be understood, corresponds to, for example, a mode in which feature symbols of the first type 416a that are selected for display in base game or bonus game outcomes may be either unenhanced feature symbols of the first type 416a or additionally enhanced versions of the feature symbols of the first type 416a. Put another way, each feature symbol of the first type may include either the first amount of corresponding trigger symbols or the third amount of corresponding trigger symbols while the first feature second mode is active.

The instructions may further cause the one or more processors to cause the base game GUI to display, while the first feature second frenzy mode is active, a first feature second frenzy mode timer configured to indicate how long until the first feature second frenzy mode deactivates.

It will be apparent that any number of first feature collection goals may be tracked by the first collection meter, and that increasing levels of upgrade or enhancement may be applied to feature symbols of the first type responsive to each such first feature collection goal being met. In other words, the above concepts are not limited to just one or two first feature collection goals and one or two enhanced versions of the feature symbols of the first type, but is inclusive of any number of such first feature collection goals and corresponding enhanced versions of the feature symbols of the first type.

It will also be apparent that the instructions may include similar instructions for causing the one or more processors to present one or more additional collection meters, e.g., a second collection meter, each of which may be used to track progress towards one or more corresponding collection goals which, when met, may cause feature symbols of a corresponding type to be enhanced, e.g., as discussed above.

For example, in some implementations, the instructions may further be configured to cause the one or more processors to cause the base game GUI to further include a second collection meter indicating progress towards meeting a second feature first collection goal.

Such instructions may also be configured to cause the one or more processors to cause a second feature first mode to be activated responsive to initialization of the second collection meter and then deactivated responsive to the second feature first collection goal being met—the second feature first mode is, it will be understood, when the feature symbols of the second type are all in an unenhanced state. For example, each feature symbol of the second type may be caused to include only one corresponding trigger symbol and a value indicator, e.g., not be associated with instant award and/or multiplier statuses, while the second feature first mode is active.

Such instructions may be further configured to cause the one or more processors cause a second feature first frenzy mode to be activated responsive to the second feature first collection goal being met and then deactivated after being active for a second feature first predetermined cumulative time period, e.g., 30 seconds or 60 seconds. The second feature first predetermined cumulative time period, it will be understood, may be the total of multiple time periods during which base game play occurs, but which are interspersed with one or more periods of time in which instances of the bonus game may occur. Each feature symbol of the second type may, for example, be caused to also be associated with an “instant award” status while the second feature first frenzy mode is active.

The instructions may also be further configured to cause the one or more processors cause a second feature second mode to be activated responsive to deactivation of the second feature first frenzy mode, e.g., after the second feature first frenzy mode has concluded. The second feature second mode is, it will be understood, when the feature symbols of the second type 416b that are displayed in base game or bonus game outcomes may be either unenhanced feature symbols of the second type 416b or enhanced versions of the feature symbols of the second type 416b. Put another way, each feature symbol of the second type may either be associated with the instant award status or not associated with the instant award status while the second feature second mode is active.

The instructions may be further configured to determine that the second feature first collection goal is met when a second feature first cumulative number of the trigger symbols has been displayed in the feature symbols of the second type in base game plays using the base game GUI since the second collection meter was last initialized. The instructions may also be configured to cause, for each of the feature symbols of the second type that is associated with the instant award status and displayed in one of the symbol positions, a value indicated by the corresponding value indication for that feature symbol of the second type to be added to a score or credit meter responsive to display of that feature symbol of the second type.

As with the first collection meter, the second collection meter may, in some cases, further indicate progress towards meeting a second feature second collection goal. In such implementations, the instructions may further cause the one or more processors to cause the second feature second mode to be deactivated and a second feature second frenzy mode to be activated responsive to the second feature second collection goal being met and then deactivated after being active for a second feature second predetermined cumulative time period. The instructions may also cause a second feature third mode to be activated responsive to deactivation of the second feature second frenzy mode. In such implementations, each feature symbol of the second type is either associated with the instant award status or not associated with the instant award status while the second feature third mode is active. Additionally, the instructions may cause the one or more processors to cause, for each of the feature symbols of the second type that is associated with the instant credit award status and displayed in one of the symbol positions while the second feature second frenzy mode or the second feature third mode are active, the value indicated by the corresponding value indication for that feature symbol of the second type to be multiplied by a multiplier, e.g., a 2× or 3× multiplier, and then added to the score or credit meter responsive to display of that feature symbol of the second type.

The instructions for any of the above implementations may, in all cases, also be further configured to cause the one or more processors to cause the base game GUI to transition to a bonus game GUI for a bonus game responsive to occurrence of a base game play in which at least a first predetermined number of the trigger symbols is displayed, the bonus game GUI including the array of symbol positions and at least the feature symbols displayed in the symbol positions in the array of symbol positions in the base game play that triggered the bonus game. The instructions may also cause the one or more processors to cause, for each bonus game play using the bonus game GUI, new selections of symbols to be displayed in the symbol positions that do not already display feature symbols and to cause the bonus game to conclude and the bonus game GUI to transition back to the base game GUI responsive to a number of bonus game plays remaining reaching zero or, in some implementations and in the alternative, a second predetermined number of the trigger symbols being displayed as a result of a bonus game play or, in another alternative, when feature symbols are displayed in all of the symbol positions displayed in the bonus game GUI. The instructions may also cause one or more processors to cause the number of bonus game plays remaining to be initially set to a threshold amount of bonus game plays remaining in association with the base game GUI being caused to transition to the bonus game GUI, decremented by one for each bonus game play that does not result in any feature symbols being displayed in symbol positions that did not display a feature symbol immediately prior to that bonus game play, and reset to the threshold amount of bonus game plays remaining responsive to a bonus game play in which one or more of the symbol positions not displaying one of the feature symbols prior to that bonus game play is caused to display one of the feature symbols as a result of that bonus game play.

It will be understood that the various first feature modes and second feature modes (and other feature modes similar thereto) may be active in parallel and independently of one another. Moreover, progress towards meeting a first feature collection goal and a second feature collection goal may also be made independently. For example, the second feature first frenzy mode may be active at the same time that first feature second mode is active, in which case all feature symbols of the second type that are displayed in base game outcomes during the while the second feature first frenzy mode is active will be enhanced versions (e.g., associated with instant award status) of the feature symbols of the second type while the feature symbols of the first type that are displayed in those base game outcomes may be either enhanced (with two trigger symbols) or unenhanced (with one trigger symbol) versions thereof.

In the event a collection goal is met while a frenzy mode is still active due to a previously met collection goal, the instructions may be configured to cause the one or more processors to handle such situations in various ways. In some instances, the time remaining in the already-in-progress frenzy mode may simply be reset to the initial time remaining for the later-triggered frenzy mode, thereby extending the already-in-progress frenzy mode, with the enhanced versions of the relevant feature symbols being exclusively used until the combined frenzy timer expires. In other examples, a second time remaining counter may be initiated for the later-triggered frenzy mode, with the exclusive use of the enhanced versions of the corresponding feature symbol types changing to non-exclusive use of the enhanced versions of those feature symbols when the corresponding timer expires.

It will also be understood that other types of enhancement may be applied to the various types of feature symbols responsive to corresponding collection goal(s) being met; the examples above are illustrative and not considered to be limiting. Other types of enhancements that may be applied to such feature symbols may be multipliers, wild status, free bonus game plays once a bonus game begins, etc.

The random selection of symbols that may be performed in the base game and/or the bonus game may be made in a variety of ways, and different random selection mechanisms may be employed in the base game compared to the bonus game.

For example, the symbols selected for display in the symbol positions of each column may be selected in a variety of ways. In some implementations, each symbol displayed in each symbol position may be selected randomly and independently from the selection of other symbols displayed in the other symbol positions. In other implementations, the symbols displayed in each of the symbol positions of each column may be randomly selected as a block from a larger, ordered sequence of symbols. For example, each column of symbol positions may be associated with a particular ordered sequence of symbols, e.g., a reel strip, and a random selection may be made of X adjacent symbols in that ordered sequence of symbols, where X is the number of symbol positions in the associated column of symbol positions (the ordered sequences of symbols may be circular or modulo sequences such that when a selected block of symbols extends past the start or end of the sequence, the symbols at the other of the end and the start of the sequence are used to provide missing symbols). Such an approach may also be used in the bonus game despite the potential presence of “held’ feature symbols in some of the symbol positions. In such a case, blocks of symbol positions may still be randomly selected, but the symbols selected for symbol positions that already have a feature symbol being held may simply be ignored and not displayed (since they are superseded by the held feature symbols).

It will be understood that the various GUIs and game mechanics discussed herein may be implemented entirely locally, e.g., by a processor or processors of a single device, such as a smartphone, or may be provided using processors located in different devices or systems. Information regarding the selection of symbols, awards associated with special symbols, etc., may be transmitted, e.g., via a network connection (wired, wireless, or a mixture of both) to another device, e.g., a smartphone, the processor or processors of which may then implement the GUI and/or feature game mechanic using the information regarding the symbols, awards, etc. Such information may be generated and/or sent in response to receipt of a request from such another device, e.g., a request from a smartphone for the server to provide such information. Such distributed-computing implementations of the GUI provisioning techniques discussed herein is to be understood to also be within the scope of this disclosure.

It will be appreciated that in such distributed computing arrangements, the computer-executable instructions for implementing the GUI may be distributed between different memory devices located in different devices, e.g., the computer-executable instructions for selecting symbols stored on one or more memory devices of a server, while the computer-executable instructions for presenting the GUI may be stored on one or more memory devices of a client gaming device, e.g., a smartphone.

In recognition of the possibility of such distributed processing arrangements, the term “collectively,” as used herein with reference to memory devices and/or processors or various other items, should be understood to indicate that the referenced collection of items has the characteristics or provides the functionalities that are associated with that collection. For example, if a server and a client device collectively store instructions for causing A, B, and C to occur, this encompasses at least the following scenarios:
a) The server stores instructions for causing A, B, and C to occur, but the client device stores no instructions that cause A, B, and C to occur.
b) The client device stores instructions for causing A, B, and C to occur, but the server stores no instructions that cause A, B, and C to occur.
c) The server stores instructions for causing a proper subset of A, B, and C to occur, e.g., A and B but not C, and the client device stores instructions that cause a different proper subset of A, B, and C to occur, e.g., C but not A and B, where instructions for causing each of A, B, and C to occur are respectively stored on either or both the client device and the server.
d) The server stores instructions for causing a subset of A, B, and C to occur, e.g., A and B but not C, and the client device stores instructions that cause a different subset of A, B, and C to occur, e.g., B and C but not A, where instructions for causing each of A, B, and C to occur are respectively stored on either or both the client device and the server.
e) The server stores instructions for causing A and a portion of B to occur, and the client device stores instructions that cause C and the remaining portion of B to occur.

In all of the above scenarios, between the server and the client device, there are, collectively, instructions that are stored for causing A, B, and C to occur, i.e., such instructions are stored on one or both devices and it will be recognized that using the term “collectively,” e.g., the server and the client device, collectively, store instructions for causing A, B, and C to occur, encompasses all of the above scenarios as well as additional, similar scenarios.

Similarly, a collection of processors, e.g., a first set of one or more processors and a second set of one or more processors, may be caused, collectively, to, perform one or more actions, e.g., actions A, B, and C. As with the previous example, various permutations fall within the scope of such “collective” language:
a) The first set of one or more processors may be caused to perform each of A, B, and C, and the second set of one or more processors may not perform any of A, B, or C.
b) The second set of one or more processors may be caused to perform each of A, B, and C, and the first set of one or more processors may not perform any of A, B, or C.
c) The first set of one or more processors may be caused to perform a proper subset of A, B, and C, and the second set of one or more processors may be caused to perform a different proper subset of A, B, and C to be performed such that between the two sets of processors, all of A, B, and C are caused to be performed.
d) The first set of one or more processors may be caused to perform A and a portion of B, and the second set of one or more processors may be caused to perform C and the remainder of B.

It is to be understood that the phrases “for each <item> of the one or more <items>,” “each <item> of the one or more <items>,” or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite the fact that dictionary definitions of “each” frequently define the term to refer to “every one of two or more things”) and would not imply that there must be at least two of those items.

The term “between,” as used herein and when used with a range of values, is to be understood, unless otherwise indicated, as being inclusive of the start and end values of that range. For example, between 1 and 5 is to be understood to be inclusive of the numbers 1, 2, 3, 4, and 5, not just the numbers 2, 3, and 4.

The use, if any, of ordinal indicators, e.g., (a), (b), (c) . . . or the like, in this disclosure and claims is to be understood as not conveying any particular order or sequence, except to the extent that such an order or sequence is explicitly indicated. For example, if there are three steps labeled (i), (ii), and (iii), it is to be understood that these steps may be performed in any order (or even concurrently, if not otherwise contraindicated) unless indicated otherwise. For example, if step (ii) involves the handling of an element that is created in step (i), then step (ii) may be viewed as happening at some point after step (i). Similarly, if step (i) involves the handling of an element that is created in step (ii), the reverse is to be understood. It is also to be understood that use of the ordinal indicator “first” herein, e.g., “a first item,” should not be read as suggesting, implicitly or inherently, that there is necessarily a “second” instance, e.g., “a second item.”

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming machine comprising:
one or more displays;
one or more processors; and
one or more memory devices storing computer-executable instructions which, when executed by the one or more processors, cause the one or more processors to:
cause a base game GUI to be displayed on the one or more displays, the base game GUI including an array of symbol positions and a first collection meter indicating progress towards meeting a first feature first collection goal;
cause a first feature first mode to be activated responsive to initialization of the first collection meter and deactivated responsive to the first feature first collection goal being met;
cause a first feature first frenzy mode to be activated responsive to the first feature first collection goal being met and deactivated after being active for a first feature first predetermined cumulative time period;
cause a first feature second mode to be activated responsive to deactivation of the first feature first frenzy mode;
cause, for each base game play using the base game GUI, symbols to be displayed in the symbol positions, wherein:
the symbols displayed in one or more of the symbol positions for each base game play are each drawn from symbols including feature symbols and non-feature symbols,
the feature symbols at least include feature symbols of a first type,
each feature symbol of the first type includes only a first amount of corresponding trigger symbols while the first feature first mode is active,
each feature symbol of the first type includes only a second amount of corresponding trigger symbols while the first feature first frenzy mode is active, wherein the second amount is larger than the first amount,
each feature symbol of the first type includes either the first amount of corresponding trigger symbols or the second amount of corresponding trigger symbols while the first feature second mode is active, and
the first feature first collection goal is met when a first cumulative number of the trigger symbols has been displayed in the feature symbols of the first type in base game plays using the base game GUI since the first collection meter was last initialized; and
cause the base game GUI to display, while the first feature first frenzy mode is active, a first feature first frenzy mode timer configured to indicate how long until the first feature first frenzy mode deactivates.

2. The electronic gaming machine of claim 1, wherein the first amount of corresponding trigger symbols is one trigger symbol and the second amount of corresponding trigger symbols is two trigger symbols.

3. The electronic gaming machine of claim 1, wherein the one or more memory devices store further computer-executable instructions which, when executed by the one or more processors, cause the one or more processors to:
cause the base game GUI to transition to a bonus game GUI for a bonus game responsive to occurrence of a base game play in which at least a first predetermined number of the trigger symbols is displayed, wherein the bonus game GUI includes the array of symbol positions and at least the feature symbols displayed in the symbol positions in the array of symbol positions in that base game play;
cause, for each bonus game play using the bonus game GUI, new selections of the symbols to be displayed in the symbol positions that do not already display feature symbols; and
cause the bonus game to conclude and the bonus game GUI to transition back to the base game GUI responsive to either a second predetermined number of the trigger symbols being displayed as a result of a bonus game play or a number of bonus game plays remaining reaching zero, wherein the number of bonus game plays remaining:
is initially set to a threshold amount of bonus game plays remaining in association with the base game GUI being caused to transition to the bonus game GUI,
is decremented by one for each bonus game play that does not result in any feature symbols being displayed in symbol positions that did not display a feature symbol immediately prior to that bonus game play, and
is reset to the threshold amount of bonus game plays remaining responsive to a bonus game play in which one or more of the symbol positions not displaying one of the feature symbols prior to that bonus game play is caused to display one of the feature symbols as a result of that bonus game play.

4. The electronic gaming machine of claim 3, wherein:
the symbols from which the symbols that are newly displayed in bonus game plays are drawn also include at least one symbol that is an expansion symbol,
the one or more memory devices store further computer-executable instructions which, when executed by the one or more processors, cause the one or more processors to cause additional symbol positions to be added to the array of symbol positions responsive to display of the expansion symbol in one of the symbol positions as a result of one of the bonus game plays and for the expansion symbol to then be replaced by a feature symbol, and
the second predetermined number is equal to a maximum number of the symbol positions in the array of symbol positions achievable during play of the bonus game.

5. The electronic gaming machine of claim 3, wherein:
the first collection meter further indicates progress towards meeting a first feature second collection goal, and
the one or more memory devices further store additional computer-executable instructions which, when executed by the one or more processors, cause the one or more processors to:
cause the first feature second mode to be deactivated responsive to the first feature second collection goal being met;
cause a first feature second frenzy mode to be activated responsive to the first feature second collection goal being met and deactivated after being active for a first feature second predetermined cumulative time period;
cause a first feature third mode to be activated responsive to deactivation of the first feature second frenzy mode, wherein:
each feature symbol of the first type includes only a third amount of corresponding trigger symbols while the first feature second frenzy mode is active, wherein the third amount is larger than the second amount, and
each feature symbol of the first type includes either the first amount of corresponding trigger symbols or the third amount of corresponding trigger symbols while the first feature third mode is active; and
cause the base game GUI to display, while the first feature second frenzy mode is active, a first feature second frenzy mode timer configured to indicate how long until the first feature second frenzy mode deactivates.

6. The electronic gaming machine of claim 5, wherein the first amount of corresponding trigger symbols is one trigger symbol, the second amount of corresponding trigger symbols is two trigger symbols, and the third amount of corresponding trigger symbols is three trigger symbols.

7. The electronic gaming machine of claim 5, wherein:
the base game GUI further includes a second collection meter indicating progress towards meeting a second feature first collection goal,
the feature symbols further include feature symbols of a second type, and
the one or more memory devices further store additional computer-executable instructions which, when executed by the one or more processors, cause the one or more processors to:
cause a second feature first mode to be activated responsive to initialization of the second collection meter and deactivated responsive to the second feature first collection goal being met;
cause a second feature first frenzy mode to be activated responsive to the second feature first collection goal being met and deactivated after being active for a second feature first predetermined cumulative time period; and
cause a second feature second mode to be activated responsive to deactivation of the second feature first frenzy mode, wherein:
each feature symbol of the second type includes the first amount of corresponding trigger symbols and a corresponding value indication,
each feature symbol of the second type is not associated with an instant award status while the second feature first mode is active,
each feature symbol of the second type is associated with the instant award status while the second feature first frenzy mode is active,
each feature symbol of the second type is either associated with the instant award status or not associated with the instant award status while the second feature second mode is active, and
the second feature first collection goal is met when a second feature first cumulative number of the trigger symbols has been displayed in the feature symbols of the second type in base game plays using the base game GUI since the second collection meter was last initialized; and
cause, for each of the feature symbols of the second type that is associated with the instant award status and displayed in one of the symbol positions, a value indicated by the corresponding value indication for that feature symbol of the second type to be added to a credit meter responsive to display of that feature symbol of the second type.

8. The electronic gaming machine of claim 7, wherein:
the second collection meter further indicates progress towards meeting a second feature second collection goal, and
the one or more memory devices further store additional computer-executable instructions which, when executed by the one or more processors, cause the one or more processors to:
cause the second feature second mode to be deactivated responsive to the second feature second collection goal being met;
cause a second feature second frenzy mode to be activated responsive to the second feature second collection goal being met and deactivated after being active for a second feature second predetermined cumulative time period;
cause a second feature third mode to be activated responsive to deactivation of the second feature second frenzy mode, wherein:
each feature symbol of the second type is associated with the instant award status while the second feature second frenzy mode is active,
each feature symbol of the second type is either associated with the instant award status or not associated with the instant award status while the second feature third mode is active; and
cause, for each of the feature symbols of the second type that is associated with the instant award status and displayed in one of the symbol positions while the second feature second frenzy mode or the second feature third mode are active, the value indicated by the corresponding value indication for that feature symbol of the second type to be multiplied by a multiplier and then added to the credit meter responsive to display of that feature symbol of the second type.

9. One or more non-transitory, computer-readable media storing computer-executable instructions which, when executed by one or more processors, cause the one or more processors to:
cause a base game GUI to be displayed on one or more displays, the base game GUI including an array of symbol positions and a first collection meter indicating progress towards meeting a first feature first collection goal;
cause a first feature first mode to be activated responsive to initialization of the first collection meter and deactivated responsive to the first feature first collection goal being met;
cause a first feature first frenzy mode to be activated responsive to the first feature first collection goal being met and deactivated after being active for a first feature first predetermined cumulative time period;
cause a first feature second mode to be activated responsive to deactivation of the first feature first frenzy mode;
cause, for each base game play using the base game GUI, symbols to be displayed in the symbol positions, wherein:
the symbols displayed in one or more of the symbol positions for each base game play are each drawn from symbols including feature symbols and non-feature symbols,
the feature symbols at least include feature symbols of a first type,
each feature symbol of the first type includes only a first amount of corresponding trigger symbols while the first feature first mode is active,
each feature symbol of the first type includes only a second amount of corresponding trigger symbols while the first feature first frenzy mode is active, wherein the second amount is larger than the first amount,
each feature symbol of the first type includes either the first amount of corresponding trigger symbols or the second amount of corresponding trigger symbols while the first feature second mode is active, and
the first feature first collection goal is met when a first cumulative number of the trigger symbols has been displayed in the feature symbols of the first type in base game plays using the base game GUI since the first collection meter was last initialized; and
cause the base game GUI to display, while the first feature frenzy mode is active, a first feature first frenzy mode timer configured to indicate how long until the first feature first frenzy mode deactivates.

10. The one or more non-transitory, computer-readable media of claim 9, wherein the first amount of corresponding trigger symbols is one trigger symbol and the second amount of corresponding trigger symbols is two trigger symbols.

11. The one or more non-transitory, computer-readable media of claim 9, further storing additional computer-executable instructions which, when executed by the one or more processors, cause the one or more processors to:
cause the base game GUI to transition to a bonus game GUI for a bonus game responsive to occurrence of a base game play in which at least a first predetermined number of the trigger symbols is displayed, wherein the bonus game GUI includes the array of symbol positions and at least the feature symbols displayed in the symbol positions in the array of symbol positions in that base game play;
cause, for each bonus game play using the bonus game GUI, new selections of the symbols to be displayed in the symbol positions that do not already display feature symbols; and
cause the bonus game to conclude and the bonus game GUI to transition back to the base game GUI responsive to either a second predetermined number of the trigger symbols being displayed as a result of a bonus game play or a number of bonus game plays remaining reaching zero, wherein the number of bonus game plays remaining:
is initially set to a threshold amount of bonus game plays remaining in association with the base game GUI being caused to transition to the bonus game GUI,
is decremented by one for each bonus game play that does not result in any feature symbols being displayed in symbol positions that did not display a feature symbol immediately prior to that bonus game play, and
is reset to the threshold amount of bonus game plays remaining responsive to a bonus game play in which one or more of the symbol positions not displaying one of the feature symbols prior to that bonus game play is caused to display one of the feature symbols as a result of that bonus game play.

12. The one or more non-transitory, computer-readable media of claim 11, wherein:
the first collection meter further indicates progress towards meeting a first feature second collection goal, and
the one or more non-transitory, computer-readable media further store additional computer-executable instructions which, when executed by the one or more processors, cause the one or more processors to:
cause the first feature second mode to be deactivated responsive to the first feature second collection goal being met;
cause a first feature second frenzy mode to be activated responsive to the first feature second collection goal being met and deactivated after being active for a first feature second predetermined cumulative time period;
cause a first feature third mode to be activated responsive to deactivation of the first feature second frenzy mode, wherein:
each feature symbol of the first type includes only a third amount of corresponding trigger symbols while the first feature second frenzy mode is active, wherein the third amount is larger than the second amount, and
each feature symbol of the first type includes either the first amount of corresponding trigger symbols or the third amount of corresponding trigger symbols while the first feature third mode is active; and
cause the base game GUI to display, while the first feature second frenzy mode is active, a first feature second frenzy mode timer configured to indicate how long until the first feature second frenzy mode deactivates.

13. The one or more non-transitory, computer-readable media of claim 12, wherein the first amount of corresponding trigger symbols is one trigger symbol, the second amount of corresponding trigger symbols is two trigger symbols, and the third amount of corresponding trigger symbols is three trigger symbols.

14. The one or more non-transitory, computer-readable media of claim 12, wherein:
the base game GUI further includes a second collection meter indicating progress towards meeting a second feature first collection goal,
the feature symbols further include feature symbols of a second type, and
the one or more non-transitory, computer-readable media further store additional computer-executable instructions which, when executed by the one or more processors, cause the one or more processors to:
cause a second feature first mode to be activated responsive to initialization of the second collection meter and deactivated responsive to the second feature first collection goal being met;
cause a second feature first frenzy mode to be activated responsive to the second feature first collection goal being met and deactivated after being active for a second feature first predetermined cumulative time period; and
cause a second feature second mode to be activated responsive to deactivation of the second feature first frenzy mode, wherein:
each feature symbol of the second type includes the first amount of corresponding trigger symbols and a corresponding value indication,
each feature symbol of the second type is not associated with an instant award status while the second feature first mode is active,
each feature symbol of the second type is associated with the instant award status while the second feature first frenzy mode is active,
each feature symbol of the second type is either associated with the instant award status or not associated with the instant award status while the second feature second mode is active, and
the second feature first collection goal is met when a second feature first cumulative number of the trigger symbols has been displayed in the feature symbols of the second type in base game plays using the base game GUI since the second collection meter was last initialized; and
cause, for each of the feature symbols of the second type that is associated with the instant award status and displayed in one of the symbol positions, a value indicated by the corresponding value indication for that feature symbol of the second type to be added to a credit meter responsive to display of that feature symbol of the second type.

15. A method comprising:
causing, by one or more processors, a base game GUI to be displayed on one or more displays, the base game GUI including an array of symbol positions and a first collection meter indicating progress towards meeting a first feature first collection goal;
causing, by the one or more processors, a first feature first mode to be activated responsive to initialization of the first collection meter and deactivated responsive to the first feature first collection goal being met;
causing, by the one or more processors, a first feature first frenzy mode to be activated responsive to the first feature first collection goal being met and deactivated after being active for a first feature first predetermined cumulative time period;
causing, by the one or more processors, a first feature second mode to be activated responsive to deactivation of the first feature first frenzy mode;
causing, by the one or more processors and for each base game play using the base game GUI, symbols to be displayed in the symbol positions, wherein:
the symbols displayed in one or more of the symbol positions for each base game play are each drawn from symbols including feature symbols and non-feature symbols,
the feature symbols at least include feature symbols of a first type,
each feature symbol of the first type includes only a first amount of corresponding trigger symbols while the first feature first mode is active,
each feature symbol of the first type includes only a second amount of corresponding trigger symbols while the first feature first frenzy mode is active, wherein the second amount is larger than the first amount,
each feature symbol of the first type includes either the first amount of corresponding trigger symbols or the second amount of corresponding trigger symbols while the first feature second mode is active, and
the first feature first collection goal is met when a first cumulative number of the trigger symbols has been displayed in the feature symbols of the first type in base game plays using the base game GUI since the first collection meter was last initialized; and
causing, by the one or more processors, the base game GUI to display, while the first feature frenzy mode is active, a first feature first frenzy mode timer configured to indicate how long until the first feature first frenzy mode deactivates.

16. The method of claim 15, wherein the first amount of corresponding trigger symbols is one trigger symbol and the second amount of corresponding trigger symbols is two trigger symbols.

17. The method of claim 15, further comprising:
causing, by the one or more processors, the base game GUI to transition to a bonus game GUI for a bonus game responsive to occurrence of a base game play in which at least a first predetermined number of the trigger symbols is displayed, wherein the bonus game GUI includes the array of symbol positions and at least the feature symbols displayed in the symbol positions in the array of symbol positions in that base game play;
causing, by the one or more processors and for each bonus game play using the bonus game GUI, new selections of the symbols to be displayed in the symbol positions that do not already display feature symbols; and
causing, by the one or more processors, the bonus game to conclude and the bonus game GUI to transition back to the base game GUI responsive to either a second predetermined number of the trigger symbols being displayed as a result of a bonus game play or a number of bonus game plays remaining reaching zero, wherein the number of bonus game plays remaining:
is initially set to a threshold amount of bonus game plays remaining in association with the base game GUI being caused to transition to the bonus game GUI,
is decremented by one for each bonus game play that does not result in any feature symbols being displayed in symbol positions that did not display a feature symbol immediately prior to that bonus game play, and
is reset to the threshold amount of bonus game plays remaining responsive to a bonus game play in which one or more of the symbol positions not displaying one of the feature symbols prior to that bonus game play is caused to display one of the feature symbols as a result of that bonus game play.

18. The method of claim 17, wherein:
the first collection meter further indicates progress towards meeting a first feature second collection goal, and
the method further comprises:
causing, by the one or more processors, the first feature second mode to be deactivated responsive to the first feature second collection goal being met;
causing, by the one or more processors, a first feature second frenzy mode to be activated responsive to the first feature second collection goal being met and deactivated after being active for a first feature second predetermined cumulative time period;
causing, by the one or more processors, a first feature third mode to be activated responsive to deactivation of the first feature second frenzy mode, wherein:
each feature symbol of the first type includes only a third amount of corresponding trigger symbols while the first feature second frenzy mode is active, wherein the third amount is larger than the second amount, and
each feature symbol of the first type includes either the first amount of corresponding trigger symbols or the third amount of corresponding trigger symbols while the first feature third mode is active; and
causing, by the one or more processors, the base game GUI to display, while the first feature second frenzy mode is active, a first feature second frenzy mode timer configured to indicate how long until the first feature second frenzy mode deactivates.

19. The method of claim 18, wherein the first amount of corresponding trigger symbols is one trigger symbol, the second amount of corresponding trigger symbols is two trigger symbols, and the third amount of corresponding trigger symbols is three trigger symbols.

20. The method of claim 18, wherein:
the base game GUI further includes a second collection meter indicating progress towards meeting a second feature first collection goal,
the feature symbols further include feature symbols of a second type, and
the method further comprises:
causing, by the one or more processors, a second feature first mode to be activated responsive to initialization of the second collection meter and deactivated responsive to the second feature first collection goal being met;
causing, by the one or more processors, a second feature first frenzy mode to be activated responsive to the second feature first collection goal being met and deactivated after being active for a second feature first predetermined cumulative time period; and
causing, by the one or more processors, a second feature second mode to be activated responsive to deactivation of the second feature first frenzy mode, wherein:
each feature symbol of the second type includes the first amount of corresponding trigger symbols and a corresponding value indication,
each feature symbol of the second type is not associated with an instant award status while the second feature first mode is active,
each feature symbol of the second type is associated with the instant award status while the second feature first frenzy mode is active,
each feature symbol of the second type is either associated with the instant award status or not associated with the instant award status while the second feature second mode is active, and
the second feature first collection goal is met when a second feature first cumulative number of the trigger symbols has been displayed in the feature symbols of the second type in base game plays using the base game GUI since the second collection meter was last initialized; and
causing, by the one or more processors and for each of the feature symbols of the second type that is associated with the instant award status and displayed in one of the symbol positions, a value indicated by the corresponding value indication for that feature symbol of the second type to be added to a credit meter responsive to display of that feature symbol of the second type.
